(19) United States
(12) Patent Application Publication
(10) Pub. No.: US 2006/0044616 A1
(43) Pub. Date: Mar. 2, 2006

(54) Gradation reproducing method, image forming apparatus, and printer driver

(76) Inventors: Taku Satoh, Kanagawa (JP); Masanori Hirano, Kanagawa (JP); Masakazu Yoshida, Kanagawa (JP); Toshihito Kamei, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/213,890

(22) Filed: Aug. 30, 2005

(30) Foreign Application Priority Data
Sep. 1, 2004 (JP) 2004-253768

(51) Int. Cl. H04N 1/40

(52) U.S. Cl. 358/3.01

(57) ABSTRACT

A gradation reproducing method includes the step of converting multi-level image data into plural-level image data having an amount of information smaller than an amount of information of the multi-level image data, by using a part having a characteristic of a dot conversion curve, so that a gradation of the multi-level image data is reproduced.

### BACKGROUND OF THE INVENTION

1. Field of the Invention

The present invention relates to a gradation reproducing method, an image forming apparatus and a printer driver.

2. Description of the Related Art

In the conventional image forming apparatuses (or image recording apparatuses) such as printers, facsimile machines and copying machines, a digital image is formed of bi-level image data made up of “1”s and “0”s or dots having ON and OFF states. But due to progress made in image forming engines and demand for realizing high-quality images, it is becoming more popular to form plural-level (or multi-level) image data which can represent pixels in plural gradation levels.

In this specification, “plural-level” is used similarly to the generally used terms “multi-level” and “bi-level”, but the amount of information included in the plural-level image data is greater than that of the bi-level image data but less than or equal to that of the multi-level image data. Normally, when carrying out image processing, the multi-level image data which are used as the input image data have an amount of information on the order of approximately 8 bits (256 values) per pixel. But in a case where the image forming apparatus which actually forms an image based on the input image data is only capable of representing approximately 1 bit to 3 bits per pixel, the image data have more levels than “bi-level” but only have a small number of levels as “multi-level”, and are thus referred to as “plural-level image data” including “bi-level”.

FIG. 1-(A) through 1-(C) are diagrams for explaining dot layout patterns which are used when carrying out the general binarization process and the multi-level process. More specifically, FIG. 1-(A) shows the dot reproduction for a case where the binarization process is carried out, FIG. 1-(B) shows the dot reproduction for a case where tone modulation is carried out, and FIG. 1-(C) shows the dot reproduction for a case where dot size modulation is carried out.

According to the dot reproduction shown in FIGS. 1-(A) through 1-(C), the amount of information is basically determined by the controllable dot size. The amount of information increases as the number of controllable dot sizes increases, to thereby enable reproduction of a high-quality picture close to the original image data. But as described above, the number of controllable dot sizes is only on the order of 1 to 3 (or 4 when 0 is included) in the case of most inkjet recording apparatuses. It is possible to improve the picture quality to a certain extent by combining the dot size modulation method and the tone modulation method, but workload is then put on the coloring agents (dyes) and recording units in order to achieve the desired picture quality. Consequently, due to cost and size restrictions on the image forming apparatus, it is only possible to improve the picture quality by two times at the most, even when the dot size modulation method and the tone modulation method are combined.

In order to compensate for the insufficient amount of information per pixel, a pseudo gradation representation which is generally referred to as a halftone process is used as a technique for controlling the number of dots per unit area. The pseudo gradation representation represents the number of dots which are arranged as a tone, and represents a large number of gradation levels by changing the density of the dots.

The halftone method includes the dither method and the error diffusion method. The dither method is popularly used for the pseudo gradation representation, and typical dither methods are the systematic dither method and the random dither method. The systematic dither method sets a sub matrix (threshold value matrix or dither matrix) made up of n×n threshold values, and overlaps this dither matrix with the input image to compare the tone level of each pixel and the corresponding threshold value in the dither matrix. A bi-level representation is made by setting a value “1” (black) if the pixel value of the input image is greater than or equal to the corresponding threshold value, and setting a value “0” (white) if the pixel value of the input image is less than the corresponding threshold value. If the processing of n×n pixels ends, the image is formed by repeatedly carrying out the above described process while successively moving the dither matrix to the position of the next n×n pixels.

FIGS. 2-(A), 2-(B) and 2-(C) are diagrams for explaining the systematic dither method. For example, with respect to input multi-level image data shown in FIG. 2-(A), a comparison is made with an n×n dither matrix shown in FIG. 2-(B) which is created by a predetermined method. Hence, only the pixels of the input image having values greater than or equal to the corresponding threshold values are replaced by dots as shown in FIG. 2-(C). Of course, it is possible to replace only the pixels of the input image having values less than the corresponding threshold values by the dots.

FIG. 2-(C) shows a case where the dots are bi-level, that is, the dots have an ON state or an OFF state. However, the dots may be made to have multi-levels by sectioning the reproducible gradation region into small, medium and large dots as shown in FIG. 3. FIG. 3 is a diagram showing a correspondence between size modulated dots and dither masks. In this case, a threshold value matrix corresponding to the dot size is used for each of the small, medium and large dots, when making the comparison with the input image data to make the replacement of the dots. FIGS. 4-(A), 4-(B) and 4-(C) are diagrams respectively showing the threshold value matrixes for the small, medium and large dots.

On the other hand, the random dither method generates a random value with respect to each pixel of the input image and uses the generated value as the threshold value. However, the image formed using the random dither method is not very smooth in general, and is unsuited for improving the picture quality as compared to the systematic dither method.

Furthermore, the pseudo gradation representation may be made by the error diffusion method. However, the error diffusion method requires a considerably complex process when compared to the dither methods. FIG. 5 is a diagram for explaining a bi-level error diffusion technique.

In FIG. 5, step ST1 carries out an error diffusion process. Black circular marks indicate the pixels having the dots which are ON, circular marks indicated by a dotted line indicate pixels having the dots which are OFF, and numerals indicate the pixels which are not yet processed. Step ST2 carries out a threshold value process. Then e_{xy} denotes an error generated by the threshold value process, and indicates a target pixel which is the target of the next error diffusion process. Step ST3 multiplies an error weight matrix EWM by the error values of the processed peripheral pixels, and calculates a corrected pixel value CPV by adding the error weight matrix EWM to the value of the next processing target pixel, which indicates the target pixel that is the target of the next error diffusion process. Step ST4 compares a fixed (or variable) threshold value and the corrected pixel value CPV, and calculates the ON and OFF states of the dots and the error value (e_{xy}), where a non-segmented image is indicated by “255” and solid color is indicated by “0”.

The error diffusion method carries out the threshold value process for each pixel and holds the error while reflecting the error to the latter calculations at a predetermined ratio. Hence, the error diffusion method can feed back to the output image even the amount of information which is forcibly discarded in the dither process, thereby making it possible to obtain picture quality which is improved over the dither image from the point of view of the resolution and the like.

Japan Patent Application Publication No. 2004-080065 discloses a conventional gradation generating method characterized by being formed in line keynote in a predetermined direction and having a high-pass filter property in parts other than the keynote when a multi-gradation image is thresholdized by the dither matrix in a part of concentration.

Meanwhile, in a case where the gradation reproducing of a digital image is implemented by using the above-mentioned halftone process method, even if an image is formed by using plural image forming apparatuses, due to the influence of mechanical or electrical unevenness held by the image forming apparatus, unevenness of the dot size or the like may be generated so that the same output may not be obtained.

Accordingly, a γ correction is generally used for correcting a tone of image data corresponding to an input and output characteristic of the image forming apparatus. In this γ correction, in a case where an image forming apparatus for printing has an input and output characteristic wherein an output result is smaller than an input, correction is made so that a higher gradation is made and thereby an output image becomes deep. On the other hand, in a case where an image forming apparatus for printing has an input and output characteristic wherein the output result is larger than the input, correction is made so that a lower gradation is made and thereby the output image becomes light. A characteristic of a dot conversion curve showing a relationship between an input gradation and an output gradation in the γ correction is called a γ curve.

Generally, multi-level image data are converted to plural-level image data by applying, for example, the halftone process (gradation reproducing process) using the above-mentioned dither matrix to the multi-level image data obtained by implementing r correction to the input multi-level gradation image data.

However, in a case where the number (256 values) of input image data obtained as a result of the γ correction is the same as the number (256 values) of the modulation reproducing that can be reproduced by the halftone process, there is a problem. That is, since the characteristic (γ curve) of the dot conversion curve used in the γ correction against an ideal input and output characteristic (which is a straight line) expands upward or downward, the reproducible modulation number is decreased. More specifically, if the γ curve is an extreme curve, an image having a low quality wherein there is no gradation change when the halftone process is done may be obtained.

### SUMMARY OF THE INVENTION

Accordingly, it is a general object of the present invention to provide a novel and useful gradation reproducing method, image forming apparatus and printer driver whereby a high quality image can be obtained.

The above object of the present invention is to provide a gradation reproducing method, including the step of:
converting multi-level image data into plural-level image data having an amount of information smaller than an amount of information of the multi-level image data, by using a part having a characteristic of a dot conversion curve, so that a gradation of the multi-level image data is reproduced.

The above object of the present invention is also to provide an image forming apparatus configured to form an image made of a plurality of dots, the image forming apparatus including:
a part having a characteristic of a dot conversion curve, the part converting multi-level image data into plural-level image data having an amount of information smaller than an amount of information of the multi-level image data, so that a gradation of the multi-level image data is reproduced.

The above object of the present invention is also to provide a printer driver configured to process image data for an image forming apparatus forming an image made of a plurality of dots, the printer driver including:
a computer program whereby a gradation reproducing method is implemented by a computer;
wherein the gradation reproducing method includes the step of:
converting multi-level image data into plural-level image data having an amount of information smaller than an amount of information of the multi-level image data, by using a part having a characteristic of a dot conversion curve, so that a gradation of the multi-level image data is reproduced.

According to the above-mentioned gradation reproducing method, in an image forming apparatus implementing the gradation reproducing method, or in a printer driver implemented by a computer, it is possible to obtain a high quality image wherein a gradation number is not decreased because multi-level image data are converted into plural-level image data having an amount of information smaller than the multi-level image data by using means having a characteristic of a dot conversion curve.

Other objects, features, and advantages of the present invention will become more apparent from the following detailed description when read in conjunction with the accompanying drawings.

### BRIEF DESCRIPTION OF THE DRAWINGS

FIG. 1 is a diagram for explaining dot layout patterns which are used when carrying out a general binarization process and a plural-level process;

FIG. 2 is a diagram for explaining a bi-level process by a dither method;

FIG. 3 is a diagram showing a correspondence between size modulated dots and dither masks;

FIG. 4 is a view for explaining an example of the dither mask of respective dot sizes;

FIG. 5 is a diagram for explaining a bi-level error diffusion technique;

FIG. 6 is a perspective view showing a structure of an embodiment of the inkjet recording apparatus according to the present invention;

FIG. 7 is a side view showing the structure of the embodiment of the inkjet recording apparatus;

FIG. 8 is a disassembled perspective view of a recording head;

FIG. 9 is a cross-sectional view of the recording head along a longitudinal direction of an ink chamber;

FIG. 10 is an enlarged view showing an important part of FIG. 9;

FIG. 11 is a cross-sectional view of the recording head along a shorter side of the ink chamber;

FIG. 12 is a plan view showing a nozzle plate of the recording head;

FIG. 13 is a system block diagram generally showing a controller of the ink-jet printer;

FIG. 14 is a system block diagram showing a driving and control section of the controller;

FIG. 15 is a system block diagram showing a head driving circuit;

FIG. 16 is a timing diagram for explaining the operation of the driving and control section;

FIG. 17 is a system block diagram showing an embodiment of an image processing apparatus according to the present invention;

FIG. 18 is a diagram for explaining a dot pattern after carrying out a Bayer type dither process and an error diffusion process with respect to an input image;

FIG. 19 is a diagram for explaining an image data after carrying out the Bayer type dither process with respect to an input image;

FIG. 20 is a graph showing the granularity measured at tone intervals of 10% for the Bayer type dither pattern and the error diffusion pattern recorded at 300 dpi;

FIG. 21 is a diagram for explaining the effects of mechanical deviations in the inkjet recording apparatus;

FIG. 22 is a diagrams for explaining interference between the Bayer type dither pattern and the mechanical deviations of the inkjet recording apparatus;

FIG. 23 is a diagram for explaining a dot layout pattern having an inclined keytone in an embodiment of a threshold value matrix according to the present invention;

FIG. 24 is a diagram for explaining the dot pattern of a line-group keytone used in electrophotography recording and the change in keytone of the gradation level;

FIG. 25 is a diagram for explaining the dot pattern of the line-group keytone applied to inkjet recording apparatus and the change in keytone of the gradation level;

FIG. 26 is a diagram for explaining the keytone formed by tiling a dither mask;

FIG. 27 is a diagram for explaining the tiling and the keytone for a case where the mask has 1 dot per gradation level;

FIG. 28 is a diagram for explaining the tiling and the keytone for a case where the mask has 2 dots per gradation level;

FIG. 29 is a diagram for explaining the tiling and the keytone for a case where the mask has 3 dots per gradation level;

FIG. 30 is a diagram for explaining division of a basic matrix into sub matrixes;

FIG. 31 is a view for explaining a different example of a matrix pattern having a line keytone in a designate direction;

FIG. 32 is a view for explaining a gradation image and an example of a low-lined matrix pattern at a certain dot;

FIG. 33 is a graph showing a human visual characteristic;

FIG. 34 is a view for explaining a part other than a keytone having a high pass filter characteristic of the matrix pattern;

FIG. 35 is a view for explaining a gradation image by a matrix having the high pass filter other than the keytone and a predetermined line keytone;

FIG. 36 is a view for explaining a differential image of an A mask and a B mask;

FIG. 37 is a graph showing an input and output characteristic in a case where the γ correction is used;

FIG. 38 is a graph showing the 255 gradation vicinity shown in FIG. 37;

FIG. 39 is a graph showing an example where dot area rates for every gradation in the dither matrix having the γ characteristic are varied;

FIG. 40 is a graph showing an example of the input and output characteristic in a case where a dither matrix having the γ characteristic is used; and

FIG. 41 is a a system block diagram showing another embodiment of an image processing apparatus according to the present invention.

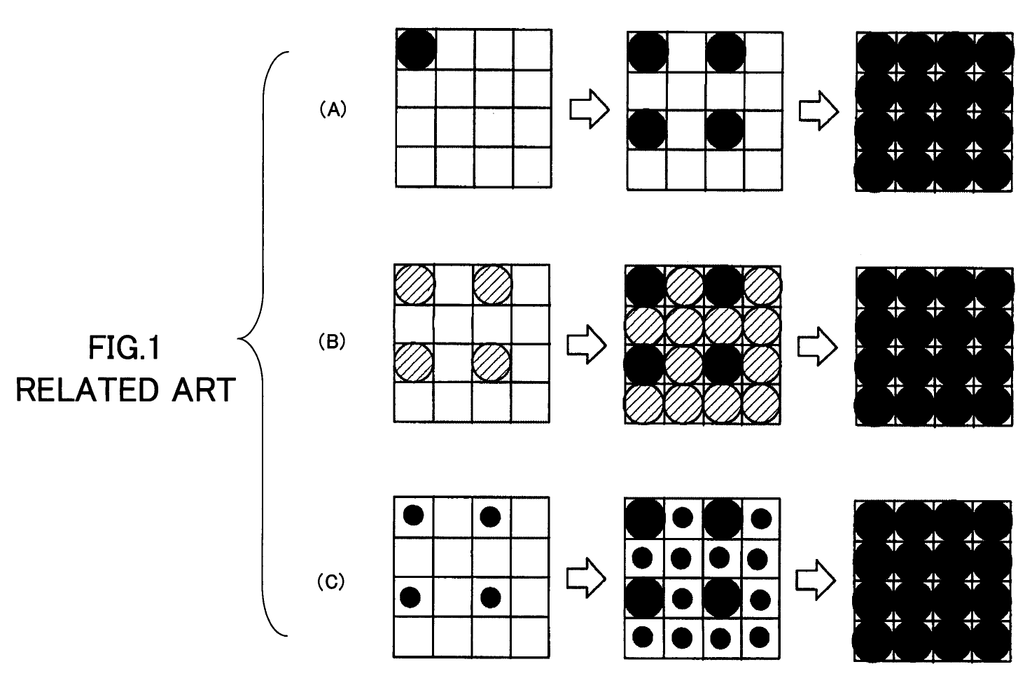

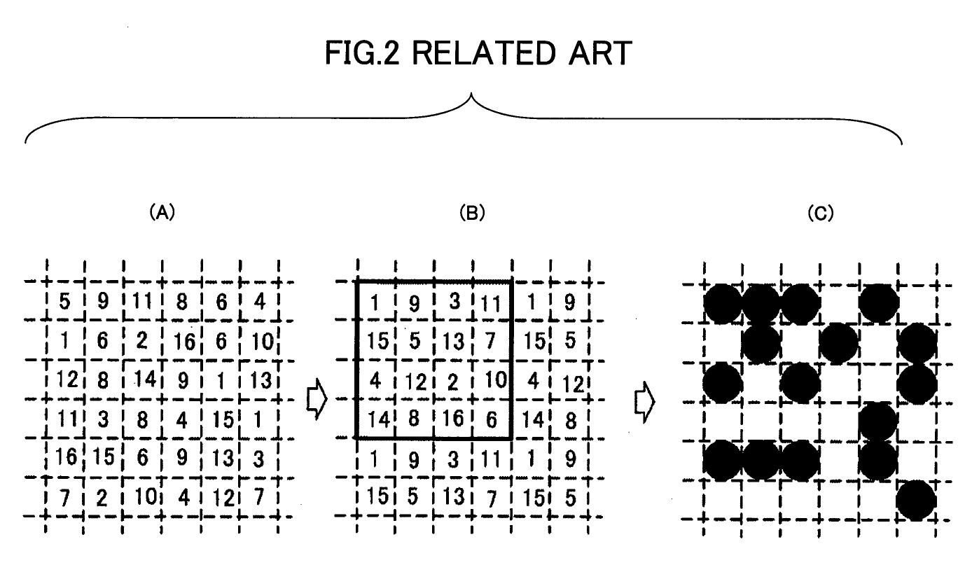

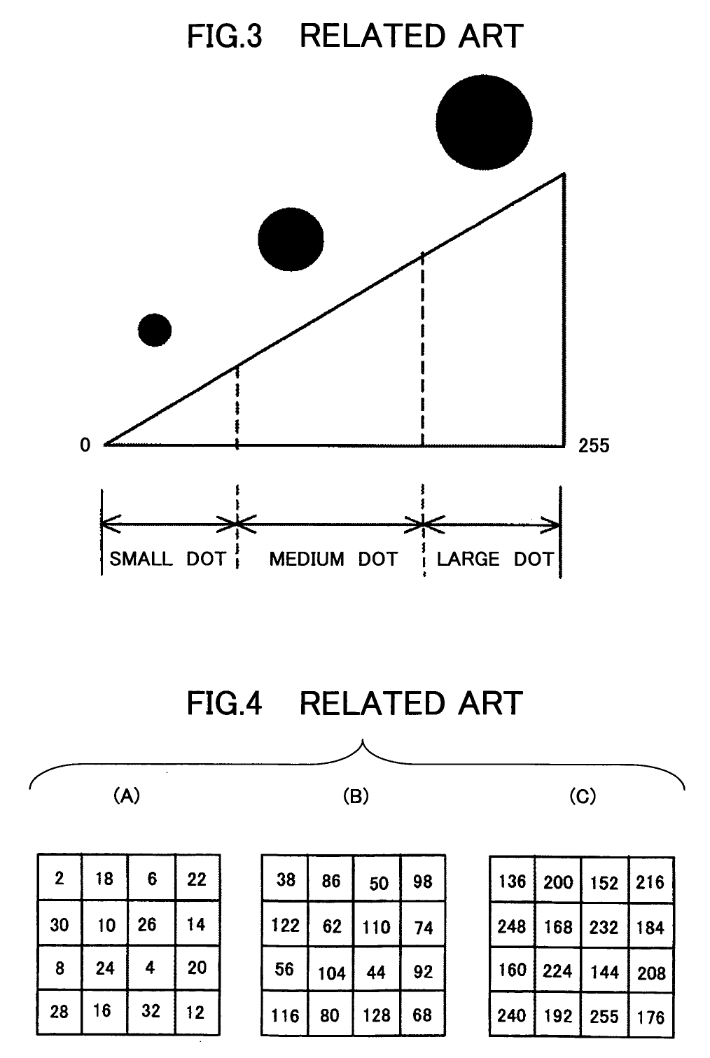

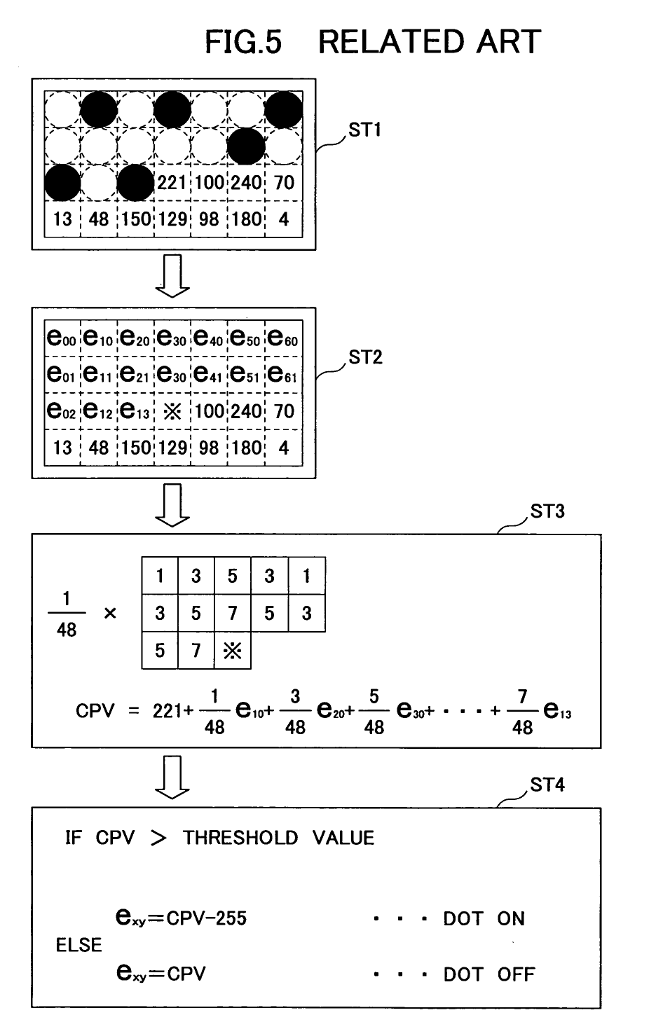

### DETAILED DESCRIPTION OF THE PREFERED EMBODIMENTS

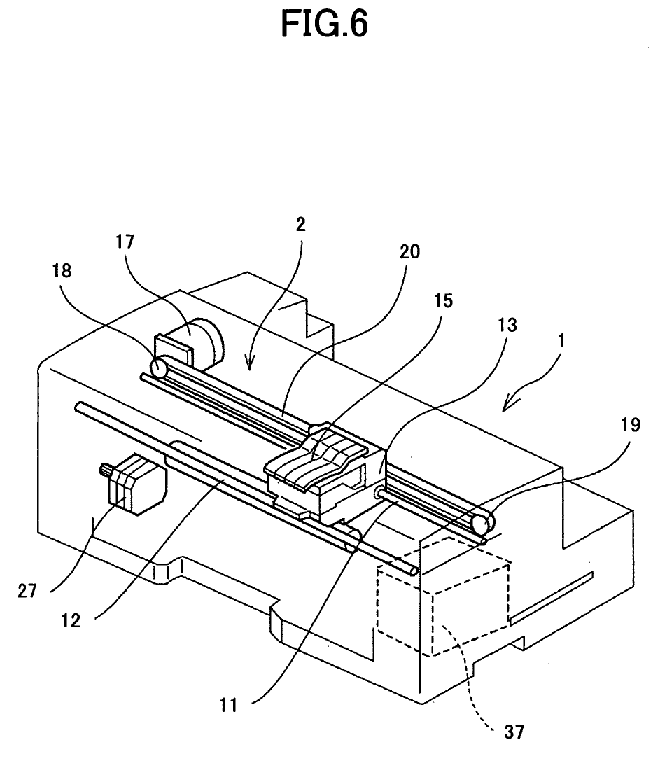

A description of the present invention is now given, with reference to FIG. 6 through FIG. 41, including embodiments of the present invention.

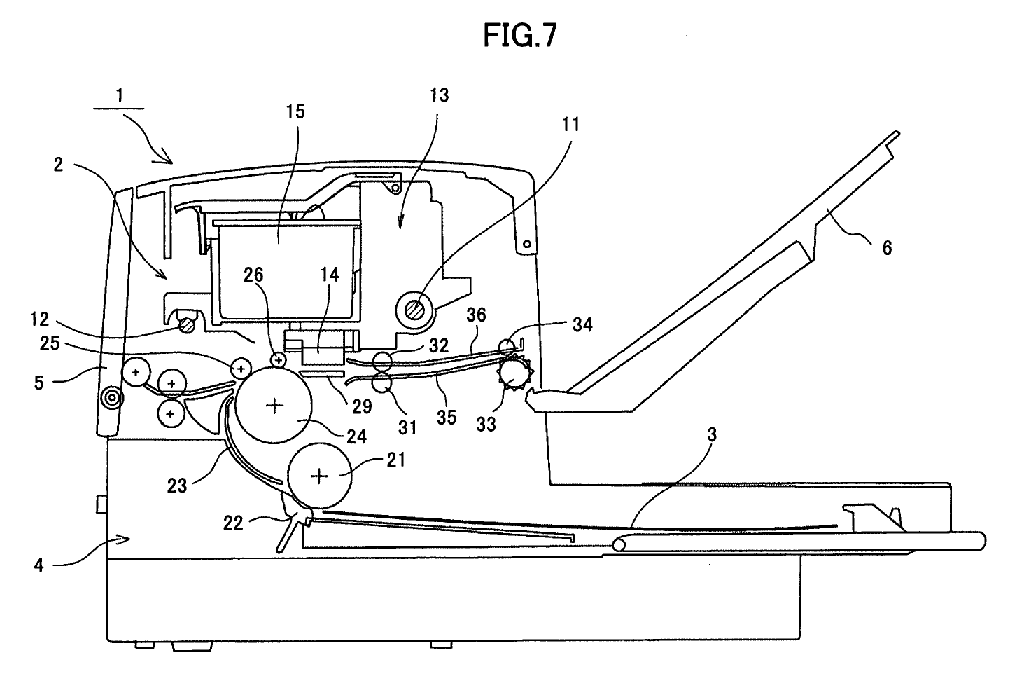

First, an example of an inkjet recording apparatus as an image forming apparatus printing print data obtained by using a gradation reproducing method of the present invention is discussed. FIG. 6 is a perspective view showing a structure of a mechanism part of the inkjet recording apparatus according to the present invention, and FIG. 7 is a side view showing the structure of the mechanism part of the inkjet recording apparatus. For the sake of convenience, FIGS. 6 and 7 show important internal parts of the image forming apparatus although actually not visible in the perspective and side views.

In the inkjet recording apparatus shown in FIGS. 6 and 7, a printing mechanism 2 is provided within a main printer body 1. The printing mechanism 2 includes a carriage 13 which is movable in a main scanning direction, recording heads 14 mounted on the carriage 13, and ink cartridges 15 for supplying inks to the recording heads 14. A paper 3 is supplied from a paper supply cassette 4 or a manual paper feed tray 5, and the printing mechanism 2 records an image on the paper 3. The paper 3 with the image recorded thereon is ejected onto a paper eject tray 6 which is located on a rear side of the main printer body 1.

In the printing mechanism 2, the carriage 13 is slidably supported by a main guide rod 11 and a sub guide rod 12 so as to be movable in the main scanning direction (in a direction perpendicular to the plane of the paper in FIG. 7). The main and sub guide rods 11 and 12 are provided between right and left side plates of the main printer body 1. The recording heads 14 are made up of inkjet heads for respectively ejecting yellow (Y), cyan (C), magenta (M) and black (Bk) inks in a downward direction. The ink cartridges (ink tanks) 15 for supplying the yellow (Y), cyan (C), magenta (M) and black (Bk) inks to the corresponding inkjet heads are detachably mounted on top of the carriage 13.

Each ink cartridge 15 has an upper opening which opens to the atmosphere, a lower opening for supplying the ink to the corresponding inkjet head 14, and a porous material which is provided inside to hold the ink. The ink within the ink cartridge 15 is maintained at a slightly negative pressure by the capillary force of the porous material. The ink is supplied from the ink cartridge 15 to the corresponding inkjet head 14.

The rear side (downstream side along the paper transport direction) of the carriage 13 is slidably supported by the main guide rod 11, and the front side (upstream side along the paper transport direction) of the carriage 13 is slidably supported by the sub guide rod 12. In order to move the carriage 13 in the main scanning direction, a timing belt 20 is stretched around a driving pulley 18 which is driven by a motor 17 and an idler pulley 19, and this timing belt 20 is fixed to the carriage 13. Hence, the carriage 13 makes a reciprocating movement as the motor 17 is rotated in the forward and reverse directions.

The recording heads 14 are made up of the ink-jet heads which eject the yellow (Y), cyan (C), magenta (M) and black (Bk) inks in this embodiment. However, it is possible to use a single recording head which ejects the yellow (Y), cyan (C), magenta (M) and black (Bk) inks. As will be described later, it is possible to use for the recording head 14 a piezoelectric type ink-jet head which includes a vibration plate forming at least a portion of a wall of an ink passage, and a piezoelectric element which deforms this vibration plate to apply pressure on the ink.

Of course, the structure of the recording head 14 is not limited to the above. For example, it is possible to use an electrostatic type inkjet head having a vibration plate forming at least a portion of the wall of the ink passage, and an electrode confronting the vibration plate, where the vibration plate is deformed by electrostatic force to apply pressure on the ink or the vibration plate is buckle-deformed by using the piezoelectric element. In addition, it is possible to use a thermal type inkjet head which generates air bubbles by heating the ink within the ink passage using a heating resistor, so as to apply pressure on the ink by the air bubbles.

On the other hand, in order to transport the paper 3 which is set in the paper supply cassette 4 under the recording head 14, the following mechanisms are provided. That is, a paper supply roller 21 and a friction pad 22 are provided to separate and supply each paper 3 from the paper supply cassette 4 toward a paper guide member 23. A transport roller 24 turns over the side of the paper 3. A transport roller 25 pushes against the peripheral surface of the transport roller 24. A tip end roller 26 restricts a feed angle of the paper 3 from the transport roller 24. The transport roller 24 is driven by a motor 27 via a gear mechanism.

A paper guide member 29 guides the paper 3 which is fed from the transport roller 24 in correspondence with the moving range of the carriage 13 in the main scanning direction, under the recording heads 14. A transport roller 31 which is driven to feed the paper 3 in the paper eject direction, is provided at a position confronting a roller 32, on the downstream side of the paper guide member 29 along the paper transport direction. Further, a paper eject roller 33 and a roller 34 are provided to eject the paper 3 onto the paper eject tray 6, and guide members 35 and 36 are arranged to form a paper eject path.

At the time of the recording, the recording heads 14 are driven in response to an image signal while moving the carriage 13, so as to eject the inks onto the stationary paper 3 and record one line. The next line is recorded after the paper 3 is transported by a predetermined amount in the paper transport direction. The recording operation is ended and the paper 3 is ejected in response to a recording end signal or a signal which indicates that a rear end of the paper 3 has reached the recording region of the recording heads 14.

A recovery unit 37 is arranged at a position on the right side in the moving direction of the carriage 13, outside the recording region. The recovery unit 37 includes cap means, suction means and cleaning means for restoring the recording heads 14 from a state where the ink-ejection is degraded or unsatisfactory. The carriage 13 is moved to the position of the recovery unit 37 during a recording wait state, so that the recording heads 14 are capped by the capping means to prevent the ink ejection nozzles of the recording heads 14 from drying and clogging. In addition, when a purge operation is carried out with respect to the ink which is not related to the recording during the recording or the like, the suction means removes the ink from the ink ejection nozzle of the corresponding recording head 14 and the cleaning means cleans the ink ejection nozzles so that the ink viscosity is maintained the same at each of the ink ejection nozzles to maintain a stable inkjet performance.

When the ink-jet ejection degrades, for example, the suction means removes the ink, air bubbles and the like from the inkjet nozzles in a state where the inkjet nozzles are sealed by the capping means. As a result, the cleaning means can remove the ink, dust particles and the like adhering in the vicinity of the inkjet nozzles, to positively restore the inkjet performance of the recording heads 14. The ink recovered by the recovery unit 37 is drained to an ink drain tank (not shown) located at the lower portion of the main printer body 1, and is absorbed by an ink absorbing material provided within the ink drain tank.

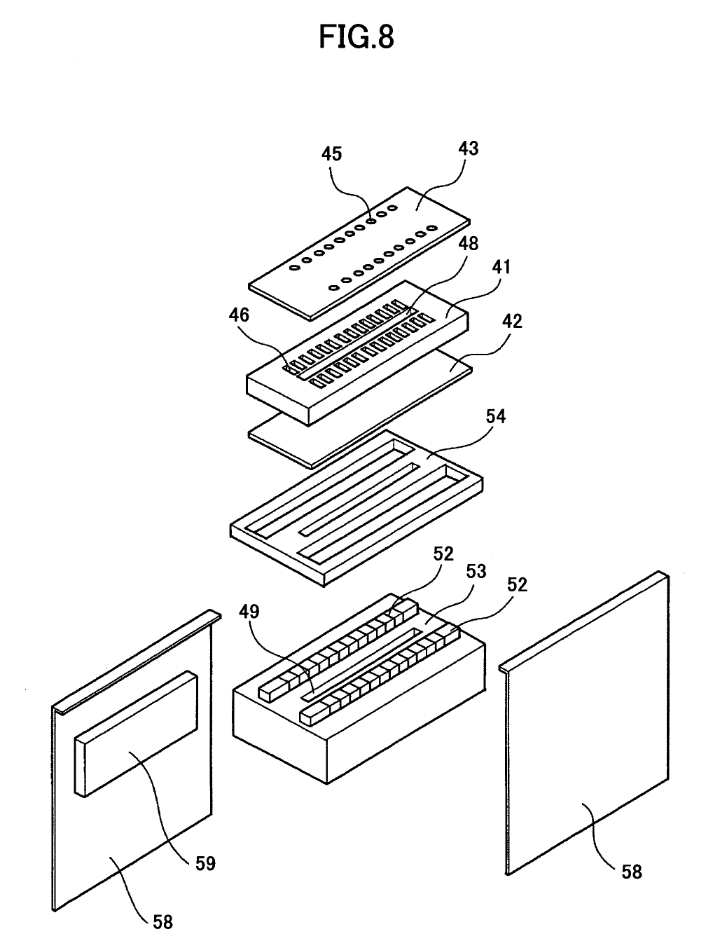

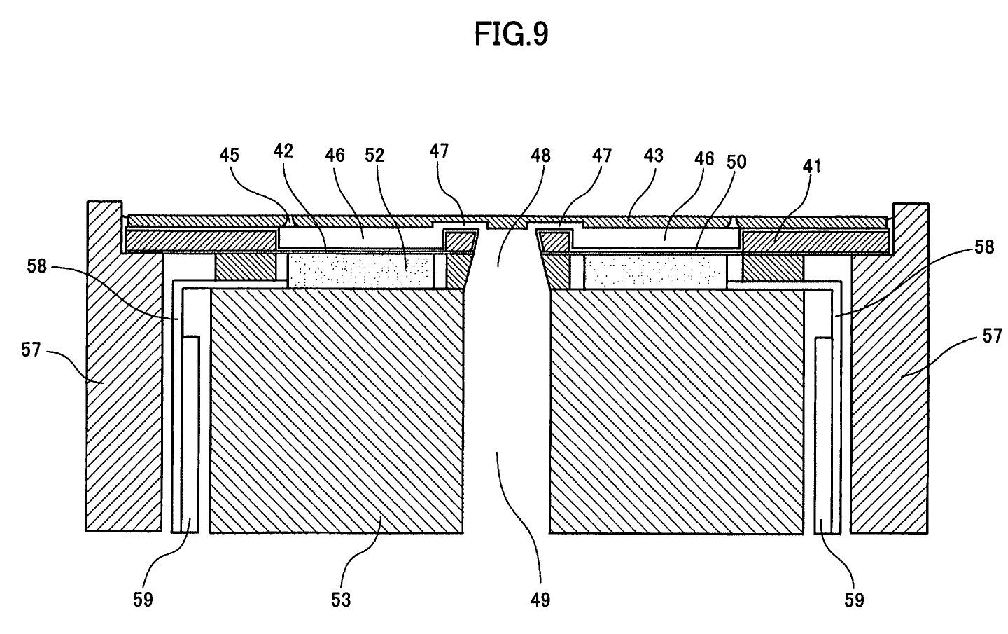

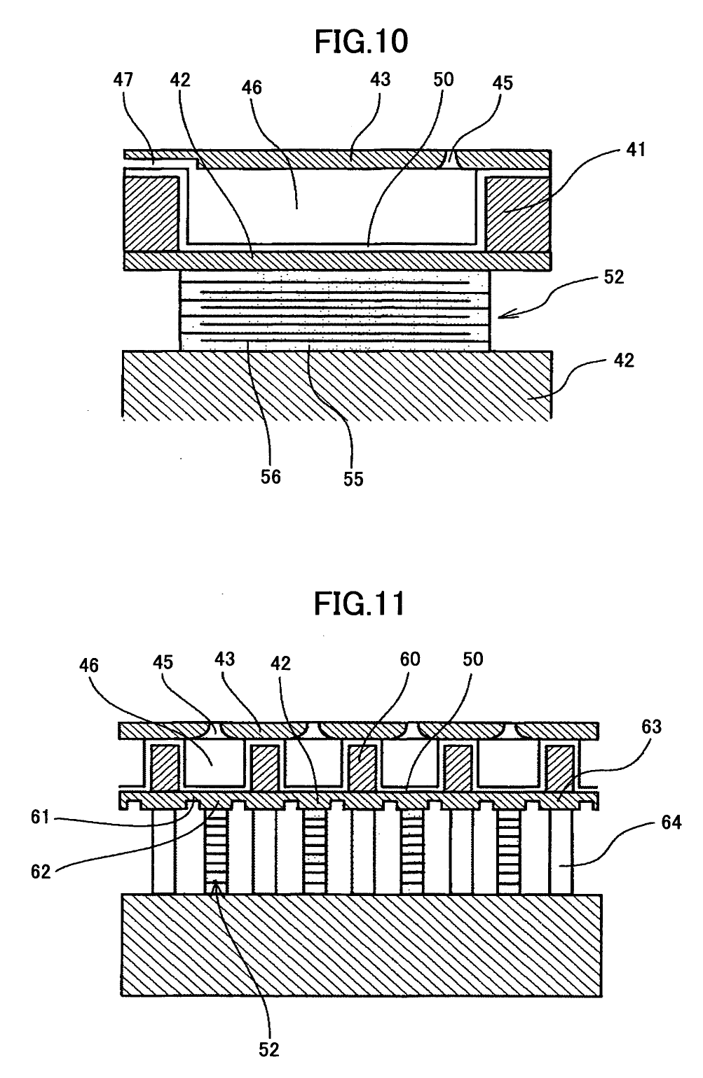

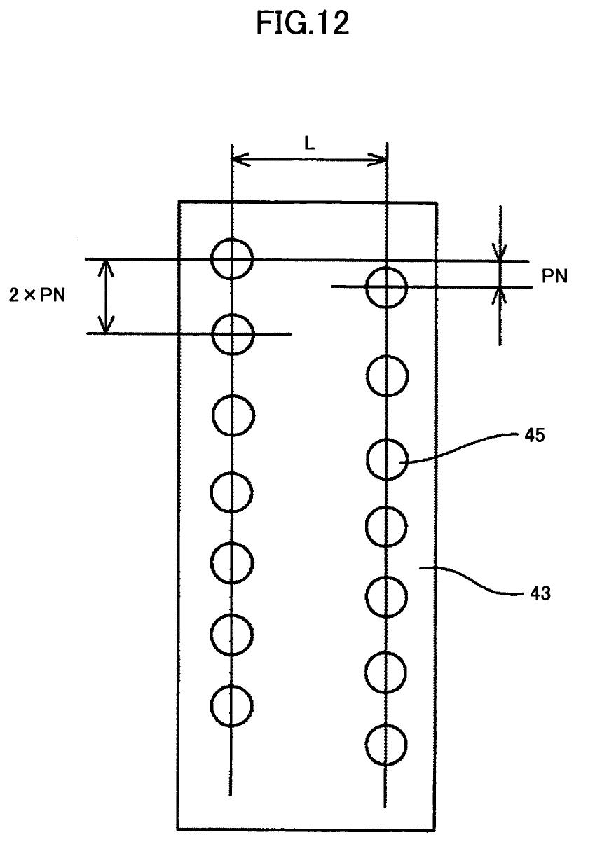

Next, a description is given of the recording head 14 of the inkjet recording apparatus with reference to FIG. 8 through FIG. 12. FIG. 8 is a disassembled perspective view of the recording head. FIG. 9 is a cross-sectional view of the recording head along a longitudinal direction of an ink chamber. FIG. 10 is an enlarged view showing an important part of FIG. 9. FIG. 11 is a cross-sectional view of the recording head along a shorter side of the ink chamber. Further, FIG. 12 is a plan view showing a nozzle plate of the recording head.

The recording head 14, that is, the ink-jet head, includes a flow passage forming substrate (flow passage forming member) 41 made of a single crystal silicon substrate, a vibration plate 42 bonded to a lower surface of the flow passage forming substrate 41, and a nozzle plate 43 bonded to an upper surface of the flow passage forming substrate 41. Ink-jet nozzles 45 for ejecting the ink are formed in the nozzle plate 43. The ink-jet nozzles 45 communicate with pressure chambers 46 which form ink flow passages. A common ink chamber 48 supplies the ink to the ink chambers 46 via ink supply passages 47 which function as a flow passage resistance portion. An ink resistant thin film 50 made of an organic resin is formed on each wall of the pressure chambers 46, the ink supply passage 47 and the common ink chamber 48 which contact the ink on the flow passage forming substrate 41.

A stacked type piezoelectric element 52 is provided in correspondence with each pressure chamber 46 on the outer surface side (surface side opposite to the common ink chamber 48) of the vibration plate 42. In addition, the piezoelectric element 52 is fixed on a base substrate 53. A spacer member 54 is provided around the rows of piezoelectric elements 52.

As shown in FIG. 10, the piezoelectric element 52 has a stacked structure alternately having a piezoelectric material 55 and an internal electrode 56.

The corresponding pressure chamber 46 is made to expand and contract due to contraction and expansion of the piezoelectric element 52 having a piezoelectric constant of d33. When a driving signal is applied to the piezoelectric element 52 and charging is carried out, expansion takes place. On the other hand, when the charge in the piezoelectric element 52 is discharged, contraction takes place in a direction opposite to the above-mentioned direction. The base substrate 53 and the spacer member 54 have penetrating holes which form an ink supply opening 49 for supplying the ink from the outside to the common ink chamber 48.

A head frame 57 is formed from an epoxy resin of polyphenylene sulfite by ejection molding. The outer peripheral portion of the flow passage forming substrate 41 and the lower outer edge portion of the vibration plate 42 are bonded to the head frame 57. The head frame 57 and the base substrate 53 are fixed to each other at a portion (not shown) by use of an adhesive agent, for example.

A flexible printed circuit (FPC) cable 58 for supplying a driving signal is connected to the piezoelectric elements 52 by soldering, anisotropic conductor film (ACF) connection, or wire bonding. A driving circuit (driver IC) 59 for selectively applying the driving signal (driving waveform) to each piezoelectric element 52 is connected to the FPC cable 58.

A (110) crystal face of the single crystal silicon forming the flow passage forming substrate 41 may be subjected to an anisotropic etching using an alkaline etchant such as a potassium hydroxide (KOH) solution, so as to form the penetrating holes which become the pressure chambers 46, a groove portion which becomes the ink supply passage 47, and the penetrating hole which becomes the common ink chamber 48.

The vibration plate 42 is made of a metal, such as nickel, by electro-forming. The vibration plate 42 has thin portions 61 corresponding to each pressure chamber 46 so as to facilitate deformation of the vibration plate 42, thick portions 62 which are bonded to the piezoelectric elements 52, and thick portions 63 corresponding to partitioning walls between the pressure chambers 46. The flat surface side of the vibration plate 42 is bonded to the flow passage forming substrate 41 by an adhesive agent, and the thick portions 62 and 63 of the vibration plate 42 are bonded to the head frame 57 by an adhesive agent. Column portions 64 are provided between the base substrate 53 and the corresponding thick portions 63 of the vibration plate 42. The column portions 64 have the same structure as the piezoelectric elements 52.

The nozzle plate 43 includes the ink-jet nozzles 45 having a diameter of approximately 10 μm to 30 μm, at positions corresponding to the pressure chambers 46. The nozzle plate 43 is bonded to the flow passage forming substrate 41 by an adhesive agent. The plural inkjet nozzles 45 form plural dot forming means. As shown in FIG. 12, the rows of nozzles 45 (nozzle rows) are arranged perpendicular to the main scanning direction. In each row of nozzles 45, the pitch between the nozzles 45 is 2×Pn. The distance between two rows of nozzles 45 is L. In addition, one row of nozzles 45 and the adjacent row of nozzles 45 are mutually shifted by a pitch Pn along the sub scanning direction, so that the nozzles 45 are arranged in a zigzag manner. Accordingly, an image having a pitch Pn can be formed by one main scan and sub scan.

The nozzle plate 43 may be made of a metal such as stainless steel and nickel, a combination of a metal and a resin film made of a polyimide resin, for example, silicon, or a combination thereof. In addition, in order to secure an ink repellant characteristic at the nozzle surface (ink ejecting surface of the nozzle plate 43 having the nozzles 45 through which the ink is ejected), an ink repellant layer is formed on the nozzle surface by a known method such as plating and ink repellant coating.

In the ink-jet head having the structure described above, the piezoelectric elements 52 have selectively applied a driving pulse voltage of approximately 20 V to 50 V, so that each selected piezoelectric element which has applied the driving pulse voltage is displaced in the direction in which the layers of the piezoelectric element 52 are stacked. As a result, each selected piezoelectric element 52 deforms the corresponding vibration plate 42 toward the nozzle 45, thereby causing a change in the volume of the corresponding pressure chamber 46. Pressure is thus applied to the ink within the pressure chamber 46, and an ink drop is ejected from the nozzle 45.

The ejection of the ink drop from the nozzle 45 causes the ink pressure within the pressure chamber 46 to fall, and a slight negative pressure is generated within the pressure chamber 46 due to inertia of the ink flow. In this state, when the driving pulse voltage applied to the piezoelectric element 52 is turned OFF, the corresponding vibration plate 42 returns to its original position and the corresponding pressure chamber 46 returns to its original shape (volume), thereby further generating a negative pressure within the pressure chamber 46. In this state, the ink is supplied from the ink supply opening 49 and is supplied into the pressure chamber 46 via the common liquid room 48 and the ink supply passage 47 which forms the flow passage resistance portion. Hence, after the vibration of the ink meniscus surface at the nozzle 45 decays and stabilizes, the driving pulse voltage is applied to the piezoelectric element 52 for the next ink ejection.

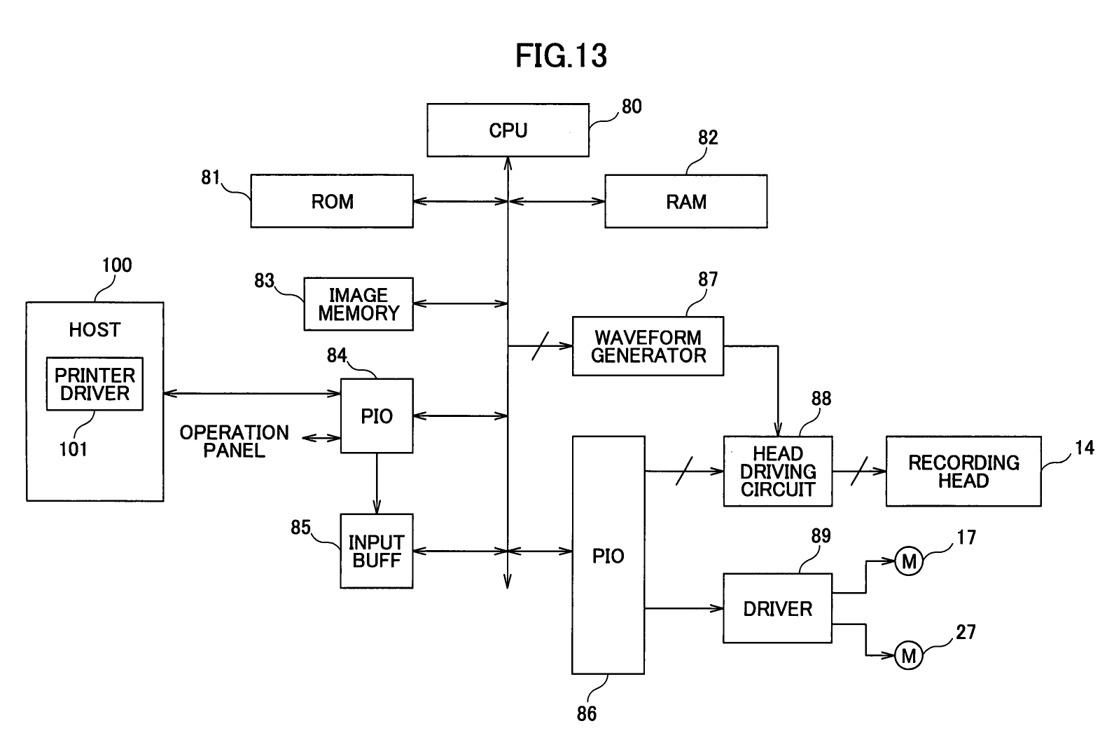

Next, a description is given of a controller of the ink-jet printer, by referring to FIG. 13. FIG. 13 is a system block diagram generally showing a controller of the inkjet recording apparatus. The controller shown in FIG. 13 includes a microcomputer (CPU) 80 which generally controls the entire inkjet recording apparatus, a ROM 81 which stores predetermined fixed information, a RAM 82 which is used as a work area, an image memory (raster data memory) 83 which stores image data (dot data or dot pattern data) transferred from a host unit 100, a parallel input and output (PIO) port 84, an input buffer 85, a parallel input and output (PIO) port 86, a waveform generating circuit 87, a head driving circuit 88 and a driver 89.

Various information items and data such as the image data transferred from a printer driver 101 of the host unit 100, and detection signals from various sensors are input to the PIO port 84. In addition, predetermined information is output with respect to the host unit 100 and an operations panel (not shown) via the PIO port 84.

The waveform generating circuit 87 generates a driving waveform to be applied to the piezoelectric elements 52 of the recording heads 14. As described below, the desired driving waveform can be generated in a simple structure by using a digital-to-analog (D/A) converter which subjects driving waveform data output from the CPU 80 to a digital-to-analog (D/A) conversion.

The head driving circuit 88 applies the driving waveform from the waveform generating circuit 87 to the piezoelectric elements 52 of the selected channels of the recording heads 14, based on various data and signals received via the PIO port 86. Further, the driver 89 drives and controls the motors 17 and 27 based on driving data received via the PIO port 86, so as to move the carriage 13 in the main scanning direction and rotate the transport roller 24 to transport the paper 3 by a predetermined amount.

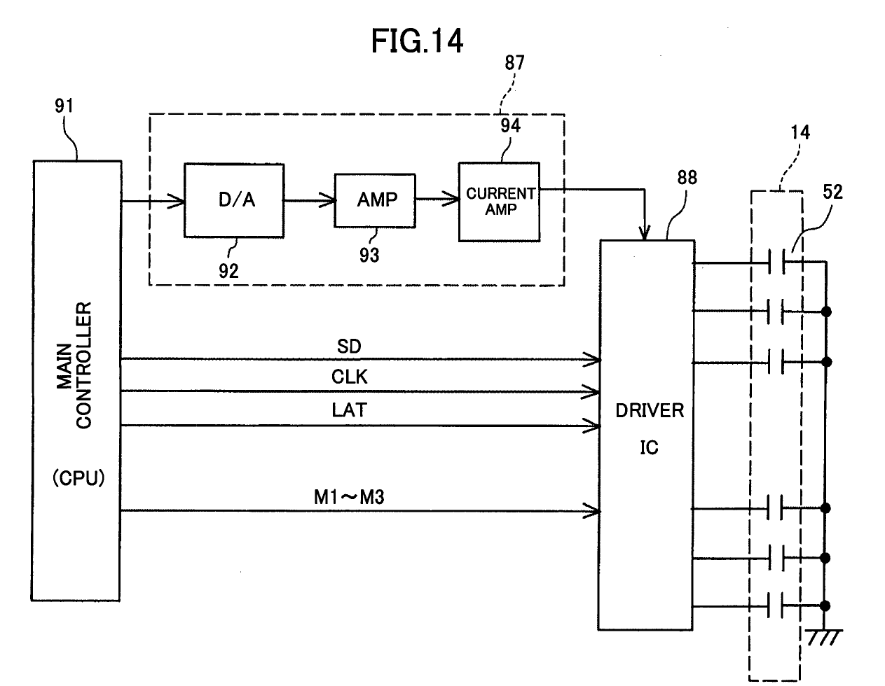

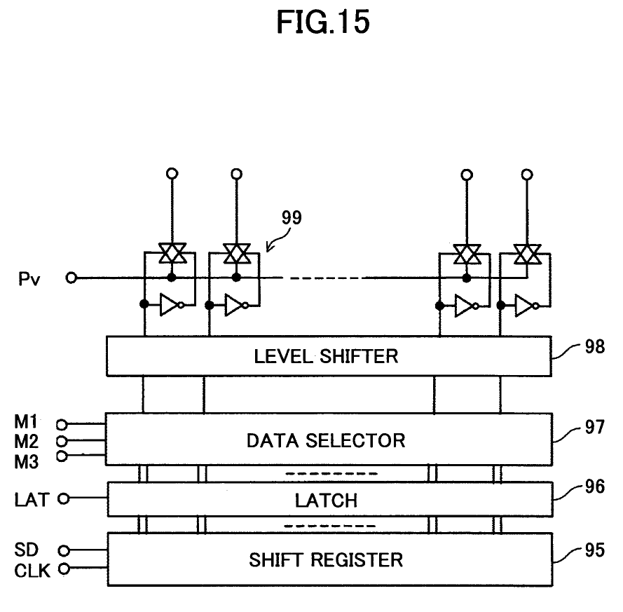

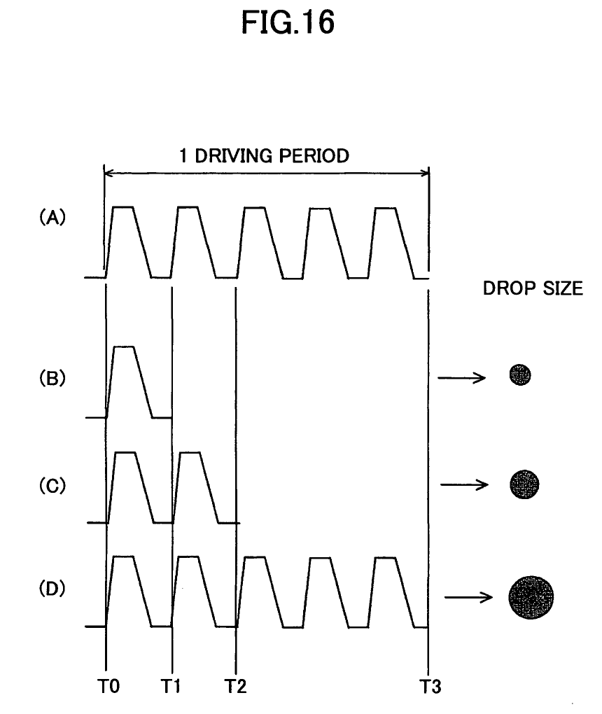

A description is given of a driving and control section of the controller related to the driving and control of the recording heads 14 with reference to FIG. 14 through FIG. 16. FIG. 14 is a system block diagram showing the driving and control section of the controller. FIG. 15 is a system block diagram showing the head driving circuit 88. FIG. 16 is a timing diagram for explaining the operation of the driving and control section.

Referring to FIG. 14, a main controller (CPU) 91 processes front data (dot data) which is received from the host unit 100 as print data, and carries out a vertical-to-horizontal conversion depending on the layout of the recording heads 14. In addition, the main controller 91 generates a 2-bit driving data SD which is required to control the ink drop to be a large drop, medium drop and small drop (and no drop or no printing) in correspondence with three-value (ternary) data, and supplies the 2-bit driving data SD to the head driving circuit (driver IC) 88. The main controller 91 also supplies to the head driving circuit 88 a clock signal CLK, a latch signal LAT, and driving waveform selection signals M1 through M3 for selecting the driving waveform in correspondence with the dot size (size of ink drop) to be formed. Furthermore, the main controller 91 reads driving waveform data stored in the ROM 81, and supplies the driving waveform data to the driving waveform generating circuit 87.

The driving waveform generating circuit 87 includes a D/A converter 92 for converting the driving waveform data received from the main controller 91 into an analog signal, an amplifier 93 for amplifying the output analog signal of the D/A converter 92 to the actual driving voltage, and a current amplifier 94 for amplifying an output of the amplifier 93 to a sufficiently high current capable of driving the recording heads 14. For example, the current amplifier 94 outputs a driving waveform Pv including plural driving pulses within one driving period as shown in FIG. 16-(A). The driving waveform Pv is supplied to the head driving circuit 88.

As shown in FIG. 15, the head driving circuit 88 includes a shift register 95 for inputting the driving data SD in response to the clock signal CLK from the main controller 91, a latch circuit 96 for latching the value of the shift register 95 in response to the latch signal LAT from the main controller 91, a data selector 97 for selecting one of the driving waveform selection signals (logic signals) M1 through M3 from the main controller 91 depending on 1-bit driving data which are latched by the latch circuit 96, a level shifter 98 for shifting an output (logic signal) of the data selector 97 to a driving voltage level, and transmission gates 99 having ON and OFF states thereof which are controlled by an output of the level shifter 98. The transmission gates 99 receive the driving waveform Pv from the driving waveform generating circuit 87, and are connected to the piezoelectric elements 52 of the corresponding nozzles of the recording heads 14.

Accordingly, in the head driving circuit 88, the data selector 97 selects one of the driving waveform selection signals M1 through M3 depending on the driving data SD, and the selected driving waveform selection signal (logic signal) is shifted to the driving voltage level by the level shifter 98. The driving voltage level output from the level shifter 98 is applied to the gates of the transmission gates 99.

As a result, the transmission gates 99 are switched depending on the duration of the selected one of the driving waveform selection signals M1 through M3, and the driving pulses forming the driving waveform Pv are applied to each channel connected to the transmission gate 99 which is ON.

For example, in a case where the driving waveform Pv includes plural driving pulses as shown in FIG. 16-(A), each transmission gate 99 which becomes ON only from a time T0 to a time T1 outputs one driving pulse as shown in FIG. 16-(B). Hence, when the driving pulse shown in FIG. 16-(B) is applied to the piezoelectric element 52, a small ink drop is ejected from the corresponding nozzle. Similarly, each transmission gate 99 which becomes ON only from the time T0 to a time T2 outputs two driving pulses as shown in FIG. 16-(C). Thus, when the driving pulse shown in FIG. 16-(C) is applied to the piezoelectric element 52, a medium ink drop is ejected from the corresponding nozzle. Further, each transmission gate 99 which becomes ON from the time T0 to a time T3 outputs five driving pulses as shown in FIG. 16-(D). Accordingly, when the driving pulse shown in FIG. 16-(D) is applied to the piezoelectric element 52, a large ink drop is ejected from the corresponding nozzle.

Therefore, by generating the driving waveform including plural driving pulses and selecting the number of driving pulses to be applied to the piezoelectric element 52, it is possible to generate the necessary driving waveforms for ejecting the small ink drop, medium ink drop and large ink drop from one driving waveform. Consequently, only one circuit is required to generate the driving waveform and only one signal line is required to supply this driving waveform. For this reason, it is possible to reduce the size of the circuit board and transmission lines and also reduce the cost thereof.

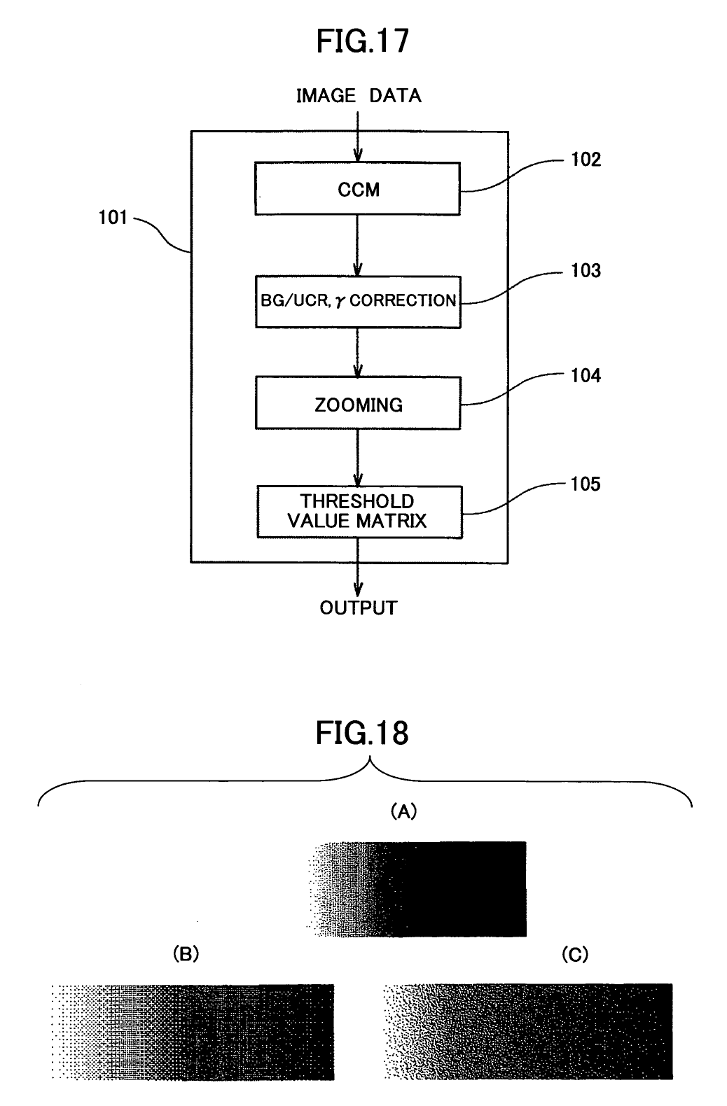

A description is now given of an embodiment of the image processing apparatus according to the present invention, by referring to FIG. 17. FIG. 17 is a system block diagram showing the embodiment of the image processing apparatus. This embodiment of the image processing apparatus is formed by the host unit 100 which transfers the image data and the like to the inkjet recording apparatus, and includes the printer driver 101, that is, an embodiment of the printer driver according to the present invention. The host unit 100 and the printer driver 101 use an embodiment of the threshold value matrix according to the present invention.

In the inkjet recording apparatus, as described above, the dot pattern to be actually recorded is received together with a print instruction or command from the host unit 100, and no means is provided within the image forming apparatus to generate the dot pattern to be recorded. Hence, the dot pattern data must be generated by the printer driver 101 which uses the embodiment of the threshold value matrix, and the dot pattern data are then transferred from the host unit 100 (the embodiment of the image processing apparatus) to the inkjet recording apparatus.

As shown in FIG. 17, the printer driver 101 of the host unit 100 includes a color management module (CMM) process section 102, a black generation/under color reduction (BG/UCR) and γ-correction section 103, a zooming process section 104, and a threshold value matrix (table) 105. For example, the image data are generated by application software of the host unit 100. The image data are processed by the CMM process section 102, the BG/UCR and γ-correction section 103, and the zooming process section 104; and the threshold value matrix (table) 105 is used to convert the multi-level image data into the dot pattern.

A description is now given of the method of creating the threshold value matrix for reproducing the gradation by a predetermined line keytone (dot layout pattern having an aligned property), by referring to FIGS. 18A through 29C.

When carrying out the image processing, if it is possible to realize a sufficiently high resolution of the formed image so as to exceed the resolving power of the human eye, the picture quality is theoretically unaffected by the kind of process carried out. But in the case of the resolution of an order which can be recognized by the human eye, there is a possibility that the characteristics generated by the process itself will become conspicuous to the human eye.

FIGS. 18-(A), 18-(B) and 18-(C) are diagrams for explaining a dot pattern after carrying out a Bayer type dither process and an error diffusion process with respect to an input image. FIG. 18-(A) through 18-(C) show the dot patterns which are actually formed by the generally used halftone process for a low-resolution recording of approximately 300 dpi. FIG. 18-(B) shows the output image after carrying out the Bayer type dither process with respect to the input image data shown in FIG. 18-(A). FIG. 18-(C) shows the output image after further carrying out the error diffusion process.

Hence, in order to reproduce the data which should be represented by a single pixel in multi-levels on the image forming apparatus not having a large number of reproducible gradation levels, it is necessary to make a pseudo gradation representation by the number of dots per unit area, that is, by the dot area ratio.

The two kinds of halftone processing methods described as examples of the pseudo gradation representation method, not only simply match the gradation levels and the area ratios, but arrange the dots approximately uniformly so that the dot layout is not biased, and adjust the dot layout so as to have a high-frequency characteristic which is less conspicuous to the human eye. When such processing is applied to a high-resolution recording of 600 dpi or 1200 dpi, the dot layout pattern is virtually inconspicuous to the human eye, and it is possible to obtain an extremely satisfactory picture quality having no unevenness in the dot distribution.

On the other hand, when a low-resolution recording of 150 dpi or 300 dpi is carried out, the dot layout pattern becomes conspicuous to the human eye even after the adjusting process to make the dot layout pattern have the high-frequency characteristic. Since a single pixel in the original image data is represented by plural pixels by the pseudo gradation representation, a texture pattern not present in the original image appears in the output image.

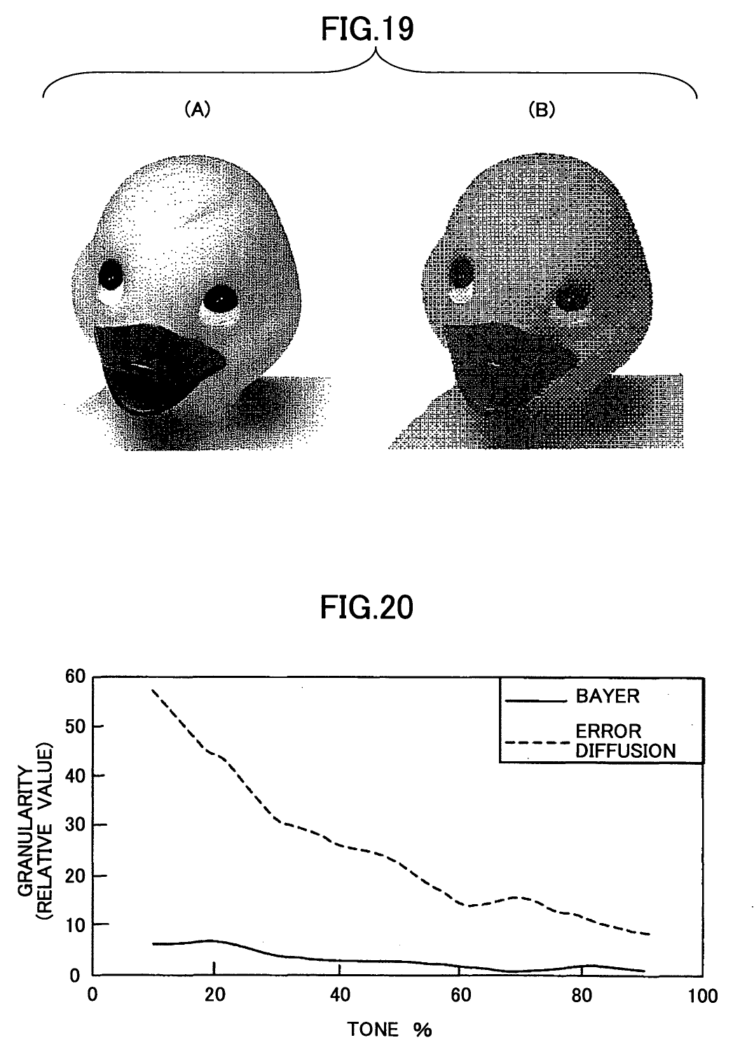

FIG. 18-(B) shows such a texture pattern. In addition, when input image data shown in FIG. 19-(A) is output with a considerably low resolution of 72 dpi, the texture pattern becomes even more notable as shown in FIG. 19-(B). FIG. 19-(A) and FIG. 19-(B) are diagrams for explaining the image data after carrying out the Bayer type dither process with respect to the input image. In FIG. 19-(B), a portion where the texture peculiar to the Bayer type dither process changes, and a portion where the dots are finely aligned so that no texture appears, are mixed to thereby result in a considerably poor quality picture.

On the other hand, in the case of the error diffusion method, the dots are formed with a layout which appears random at first glance. This random dot layout is maintained for all of the gradation levels, and the texture will not change at the gradation levels and no fixed texture exists, as may be seen from FIG. 18-(c). Because no fixed texture exists, interferences with respect to mechanical deviations in the image forming apparatus are less likely to occur, and a high resolution characteristic is obtainable compared to the Bayer type dither process or the like since there is a certain degree of freedom of the dot layout.

However, according to the error diffusion process, the granularity may be poor when compared to the Bayer type dither process, as shown in FIG. 20. FIG. 20 is a graph showing the granularity measured at tone intervals of 10% for the Bayer type dither pattern and the error diffusion pattern recorded at 300 dpi. Hence, the random nature of the dot layout used in the error diffusion process, intended to obtain various advantageous effects, actually cause problems at low resolution. In other words, at the low resolution, a conspicuous noise component is easily recognized in the case of the error diffusion process, and the aligned texture generated in the case of the Bayer type dither process tends to be better when a sensual evaluation is made.

Therefore, it may be understood from the above that the kind of texture pattern formed by the dot layout greatly affects the picture quality. In order to obtain a satisfactory picture quality at low resolution using the two kinds of halftone processing methods, the present inventors found that it is necessary to form a dot layout pattern having good alignment and not to change the dot layout pattern or not to make the change in the dot layout pattern visible for each of the gradation levels.

In the embodiment of the threshold value matrix, the dot reproduction is made while constantly maintaining a predetermined line keytone (dot layout pattern having an aligned property) for all halftone levels, using only the dot layout pattern. Hence, it is possible to improve the picture quality when making a multi-level representation by a small number of values, on the order of approximately 1 bit to 3 bits, during the recording of the image forming apparatus at low resolution. It is possible to obtain satisfactory recording (print) data particularly when applied to the inkjet recording apparatus employing the dot size (diameter) modulation.

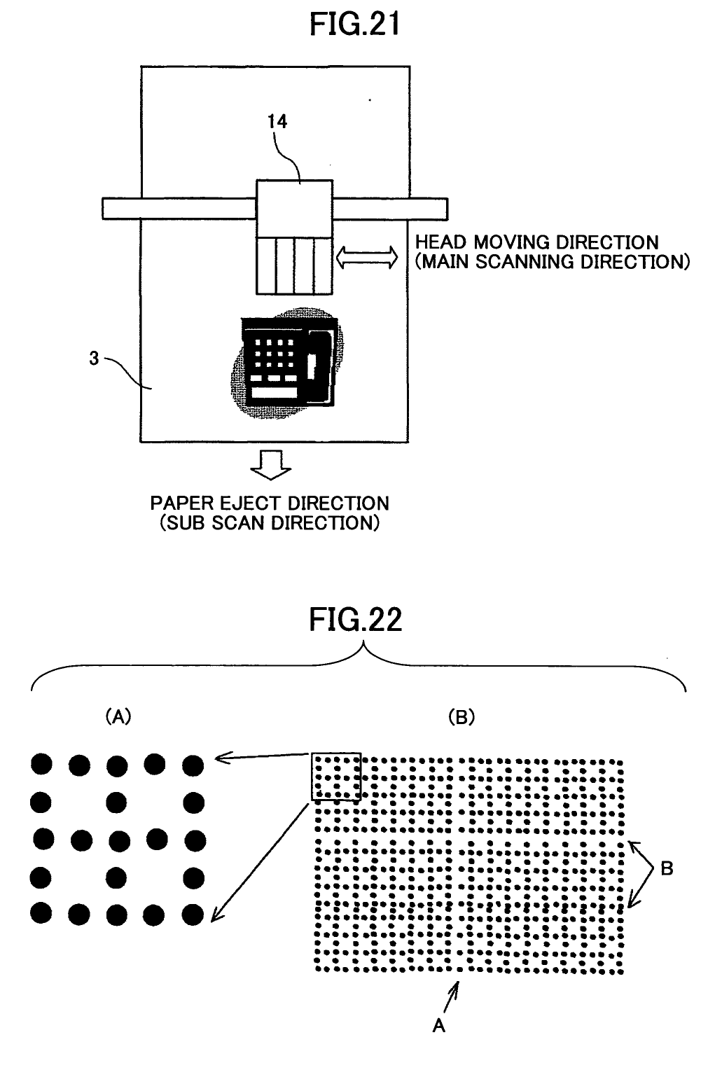

When considering the dot layout pattern having the aligned property (predetermined line keytone), it is always necessary to take into consideration the correlation with the mechanical deviations of the image forming apparatus. In other words, as in the case of the inkjet recording apparatus described above, the recording unit including the recording heads 14 and the carriage 13 carries out the recording while moving in the main scanning direction depending on the transport of the paper 3 as shown in FIG. 21. FIG. 21 is a diagram for explaining the effects of the mechanical deviations in the inkjet recording apparatus. In this case, if inconsistencies exist in the accuracy of the paper transport in the sub scanning direction and the head moving speed in the main scanning direction, interference may occur with the predetermined line keytone and generate recognizable vertical and horizontal stripes.

FIG. 22-(A) and FIG. 22-(B) are diagrams for explaining interference between the Bayer type dither pattern and the mechanical deviations of the ink-jet printer. FIG. 22-(B) shows the interference which is generated when outputting one gradation pattern of the Bayer type dither pattern shown in FIG. 22-(A). It may be seen from FIG. 22-(B) that when the keytone is aligned in the vertical and horizontal directions, synchronization easily occurs with deviations A and B in the main and sub scanning directions. Since the human eye is sensitive with respect to the 0-degree and 90-degrees (180-degrees and 270-degrees) directions, it is desirable to avoid the keytone which easily aligns in the vertical and horizontal directions. However, as described above with respect to the error diffusion method, the random dot layout which is least likely to generate the interference is undesirable for the low resolution because the noise component is emphasized and become recognizable.

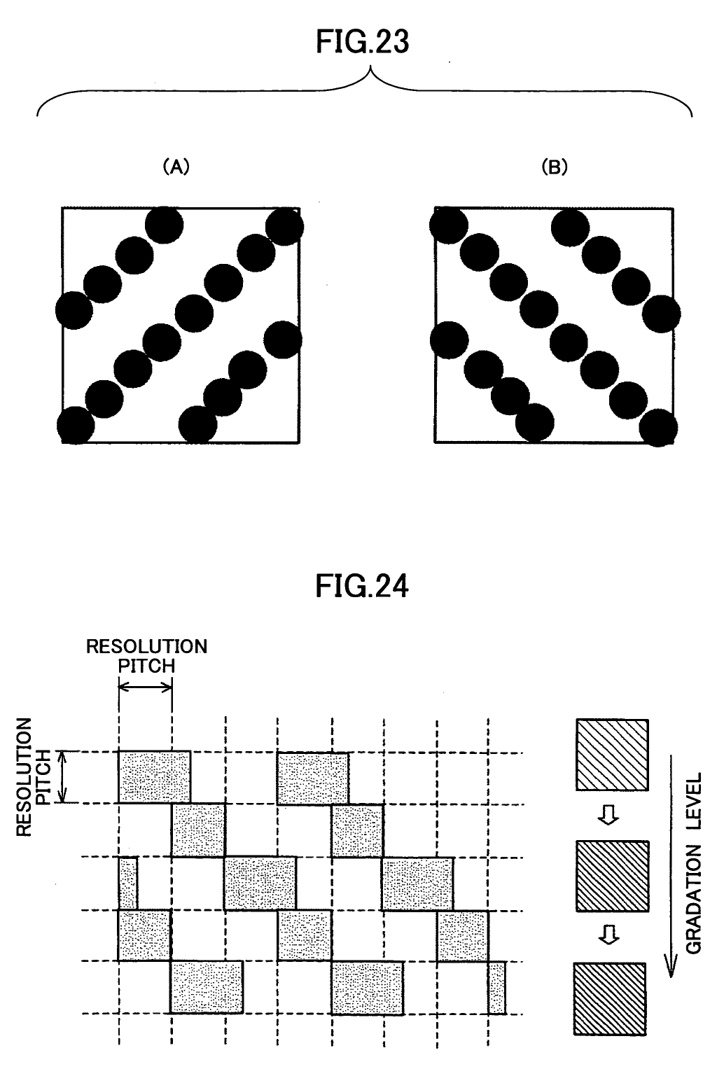

Accordingly, a dot layout pattern having an inclined keytone is desired, as shown in FIG. 23-(A) and FIG. 23-(B). FIG. 23-(A) and FIG. 23-(B) are diagrams for explaining the dot layout pattern having the inclined keytone in an embodiment of a threshold value matrix according to the present invention. The same effects can be obtained with respect to deviations in both the main scanning direction and the sub scanning direction, by using a line-group keytone such as a 45-degrees inclined keytone and a 135-degrees inclined keytone, as shown in FIG. 23-(A) and FIG. 23-(B). Furthermore, since the human eye is slightly less sensitive with respect to the oblique direction, the inclined keytone tends to be less conspicuous than the vertical and horizontal keytones. But since the main purpose here is to align the keytone, and not to make the interference (which conventionally causes problems) inconspicuous, an advantageous characteristic can be derived therefrom.

The line-group keytones shown in FIG. 23-(A) and FIG. 23-(B) are referred to as “line-group type dither” and used in electrophotography recording. In the electrophotography recording, a latent image is formed on a charged photoconductive body by a laser beam, and the latent image is made visible by toner as a toner image. The toner image is transferred onto a recording medium such as paper. Hence, the dot size can be controlled in several stages by modulating the laser power, but the electrophotography recording is not suited for making the gradation representation using small dots because the toner adhering and transfer characteristics may be degraded for small dots. Hence, an area modulated (AM) dither method which gradually forms the large dot by concentrating the dots as much as possible, is generally employed for the electrophotography recording.

The line-group type dither method is a kind of AM dither method. Although the line-group type dither method has directionality, it is advantageous in that the dots can be grown in a spiral manner and that the recording density (number of lines or line density) can be improved compared to the concentration type dither method.

However, when the line-group type dither method used in the electrophotography recording is applied as it is to the inkjet recording or other recording techniques other than the electrophotography recording, the keytone is not aligned appropriately. In other words, in the case of the electrophotography recording, it is possible to adjust not only the dot size but also the dot forming position, as may be seen from FIG. 24-(A). Hence, as may be seen from FIG. 24-(B), no matter how the dots are arranged, that is, no matter how the gradation level changes, it is possible to represent the gradation levels without destroying the shape of the oblique line. FIG. 24-(A) and 24-(B) are diagrams for explaining the dot pattern of a line-group keytone used in electrophotography recording and the change in keytone of the gradation level.

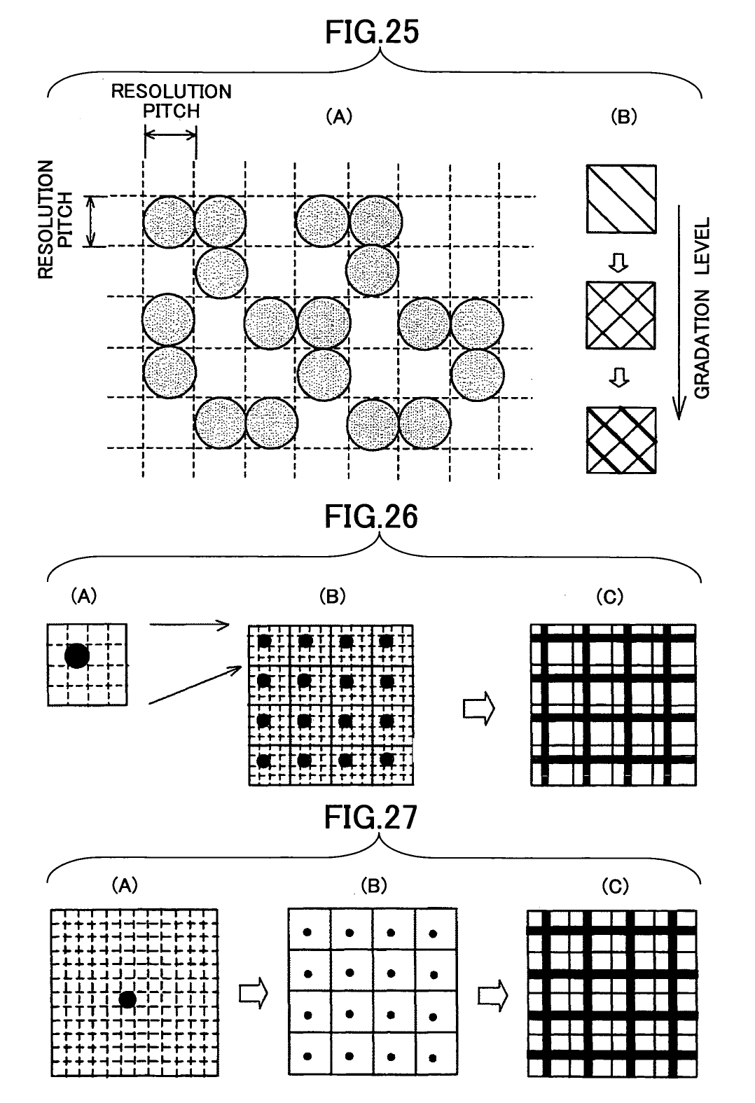

On the other hand, when the line-group type dither method used in the electrophotography recording is applied as it is to the inkjet recording apparatus, the dot forming positions are fixed to the pitch determined by the recording resolution, as shown in FIG. 25-(A). For this reason, the keytone changes even when the number of dots slightly increases, as shown in FIG. 25-(B), and it is impossible to achieve the original intention which is to realize a processing method which does not change the keytone or does not make the change in keytone conspicuous. FIG. 25-(A) and FIG. 25-(B) are diagrams for explaining the dot pattern of the line-group keytone applied to the ink-jet recording and the change in keytone of the gradation level.

Particularly in the case of the general dither process, the same mask is tiled into square shapes and used, in order to simplify the processing mechanism and achieve high-speed processing at low cost. Hence, even if the number of dots increases by 1 dot, this increase is recognized as a pattern which is aligned vertically and horizontally with the tiling period.

For example, when a 4×4 dither mask shown in FIG. 26-(A) is used to carry out the tiling as shown in FIG. 26-(B), the dots become aligned as a whole, vertically and horizontally. As a result, a lattice keytone is generated as shown in FIG. 26-(C). FIG. 26-(A), FIG. 26-(B) and FIG. 26-(C) are diagrams for explaining the keytone formed by tiling the dither mask.

Accordingly, in order to maintain the group-line keytone and to avoid a change in the keytone by this tiling, this embodiment generates three or more dots simultaneously per single gradation level.

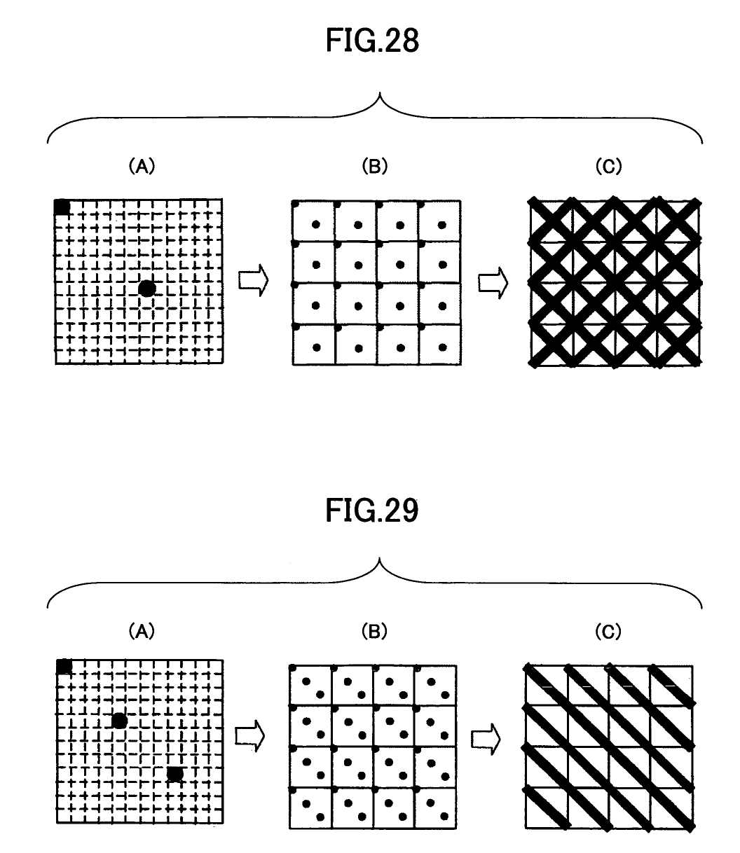

In other words, in a case where the reproduction is made by the inclined line-group keytone, when a mask having 1 dot per single gradation level as shown in FIG. 27-(A) is tiled as shown in FIG. 27-(B), a lattice keytone which is aligned vertically and horizontally is obtained as shown in FIG. 27-(C). FIG. 27-(A), FIG. 27-(B) and FIG. 27-(C) are diagrams for explaining the tiling and the keytone for the case where the mask has 1 dot per gradation level. In addition, in a case where the reproduction is made by the inclined line-group keytone, when a mask (having an obliquely arrange dot layout) having 2 dots per single gradation level as shown in FIG. 28-(A) is tiled as shown in FIG. 28-(B), an inclined keytone which is aligned obliquely is obtained as shown in FIG. 28-(C). In FIG. 28-(C), the inclined keytone has the 45-degrees alignment and the 135-degrees alignment which intersect. FIG. 28-(A), FIG. 28-(B), and FIG. 28-(C) are diagrams for explaining the tiling and the keytone for the case where the mask has 2 dots per gradation level.

On the other hand, in a case where the reproduction is made by the inclined line-group keytone, when a mask having 3 dots per single gradation level as shown in FIG. 29-(A) is tiled as shown in FIG. 29-(B), an inclined keytone which is aligned only in one oblique direction is obtained as shown in FIG. 29-(C). FIG. 29-(A), FIG. 29-(B) and FIG. 29-(C) are diagrams for explaining the tiling and the keytone for a case where the mask has 3 dots per gradation level. A similar inclined keytone is obtained when the mask has more than 3 dots per single gradation level.

In this case, simultaneously forming 3 or more dots per single gradation level requires a mask size which is 3×3=9 times or greater in order to obtain the same capability of reproducing the gradation levels. This value of 9 times or greater is small compared to the size of the buffer memory or the like required for error diffusion processing. Unless an extremely large mask is used as a reference, this size of the mask size does not decrease the processing speed or increase the cost. Of course, in order to achieve high-speed processing, it is desirable that the vertical and horizontal sizes of the mask can easily be processed by a computer. In other words, it is desirable to make the mask size a multiple of 8, so that odds numbers are not generated upon processing and loading into a memory.

Next, a description is now given of an enlargement of the mask size, by referring to FIG. 30-(A) through FIG. 30-(F). FIG. 30-(A) through FIG. 30-(F) are diagrams for explaining division of a basic matrix into sub matrixes. When a reference mask shown in FIG. 30-(A) which has the inclined line-group keytone is used as a reference to form a mask shown in FIG. 30-(B) for the case where 4 dots are simultaneously generated, each cell of the reference mask shown in FIG. 30-(C) is further divided into smaller sub matrixes as shown in FIG. 30-(D) and FIG. 30-(E) so as to obtain the necessary number of gradation levels. In this case, by making the sub matrixes have figures similar to the reference mask so as to have the inclined line-group keytone, it is possible to prevent a pattern which destroys the keytone from being generated.

For example, the 3×3 sub matrix shown in FIG. 30-(D) can represent 36 gradation levels. In addition, the 4×4 sub matrix shown in FIG. 30-(E) can represent 64 gradation levels.

It is possible to use a 2×2 sub matrix shown in FIG. 30-(F), but a checkerboard pattern keytone is generated during the process of representing the gradation levels when the 2×2 sub matrix is used. For this reason, this embodiment sets a minimum unit of the sub matrix to be a 3×3 inclined line-group mask. By using the sub matrixes described above, it is possible to suppress generation of another keytone which would destroy the inclined line-group keytone.

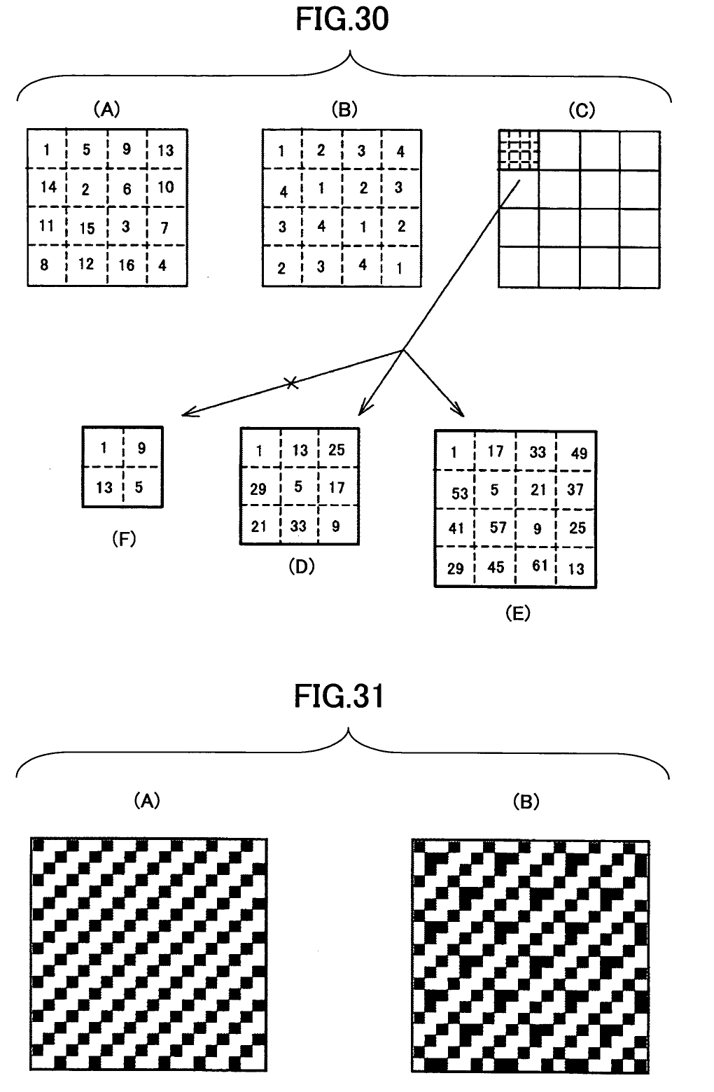

Meanwhile, in a case where a threshold value matrix (dither matrix) formed in a line keytone in a predetermined direction such as a line-group keytone as described above is used, a low-lined state at a dot of a part is generated so that continuity of the gradation is not maintained and thereby image quality may be degraded. That is, FIG. 31 shows an example of a matrix pattern having a line keytone in a designated direction, and more specifically a part of the matrix pattern formed in a predetermined line keytone. Dot wherein it is difficult to maintain such a line keytone exist.

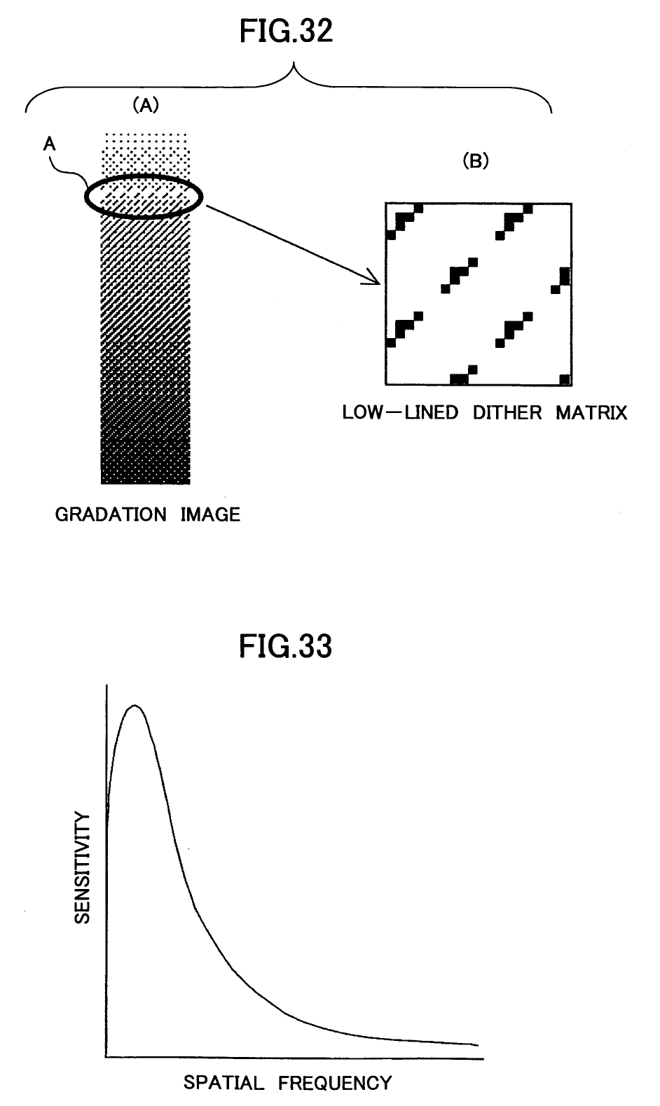

For example, like the gradation image as shown in FIG. 32-(a), a matrix pattern is low-lined in a dot at an A part as shown in FIG. 27-(b) so that the continuity of the gradation is cut and thereby the image quality may be degraded.

Thus, in order to solve a problem of degrading of the image quality due to a low-line at a curtain dot in the threshold matrix (dither matrix) formed in the line keytone of the predetermined direction, a low-lined dot range is selected and a dot arrangement of a matrix between the dots is determined so as to have a high pass filter characteristic and a line keytone in a predetermined direction.

A spatial frequency characteristic of human visual acuity based on a spatial frequency analysis is applied to the high pass filter so that a low spatial frequency characteristic is extracted. FIG. 33 is a graph showing a human visual characteristic. The spatial frequency characteristic of the human visual acuity is approximately calculated by the following equation (1) and a spatial frequency F on a retina.
VTF(f) 5.05(e^{-0.138f})(1−e^{-0.1f}) (1)

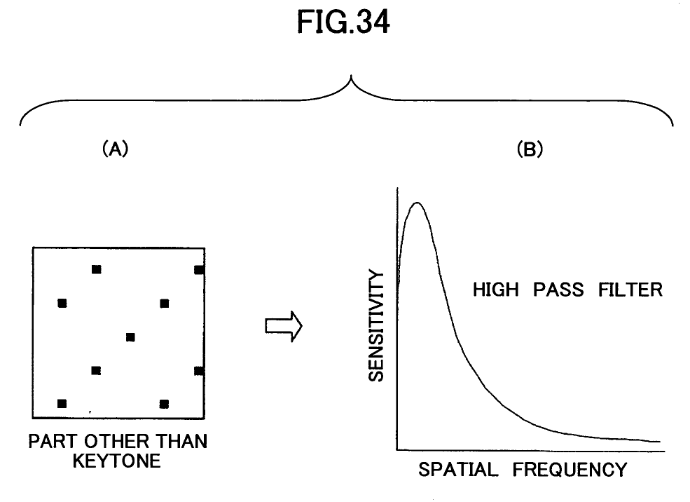

FIG. 34 is a view for explaining a part other than a keytone having a high pass filter characteristic of the matrix pattern. A characteristic of a part other than a keytone is a high pass filter as shown in FIG. 34-(b).

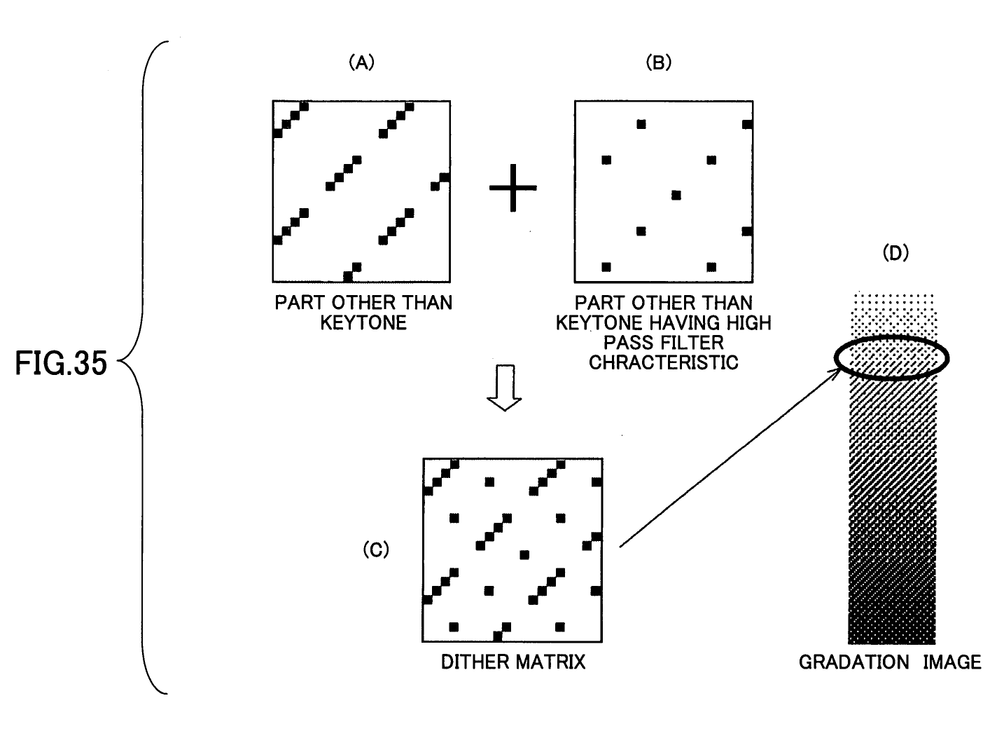

FIG. 35 is a view for explaining a gradation image by a matrix having the high pass filter other than the keytone and a predetermined line keytone.

A part of a line keytone shown in FIG. 35-(A) and a part other than the line keytone, the part having a high pass filter as shown in FIG. 35-(B) are combined so that a dither matrix of the present invention as shown in FIG. 35-(C) is obtained. By using the dither matrix at a dot part at a part A shown in FIG. 35-(A), it is possible to obtain a gradation image wherein a dot is continuous as shown in FIG. 35-(D).

In this case, when the dither matrixes between the dots at a part are bi-level images, a high pass filter characteristic is provided at the difference image of the both images.

That is, in the dither method, the threshold value set at a low dot side exists in a high dot side in a case where an A mask is set at a position where the dot is low and a B mask is set at a position where the dot is high of a part of the above-mentioned dither matrix. The line keytone existing in the A mask also exists in the B mask. Therefore, if the difference of the bi-level image of the A mask is calculated from the bi-level image of the B mask, an image having no line keytone can be obtained.

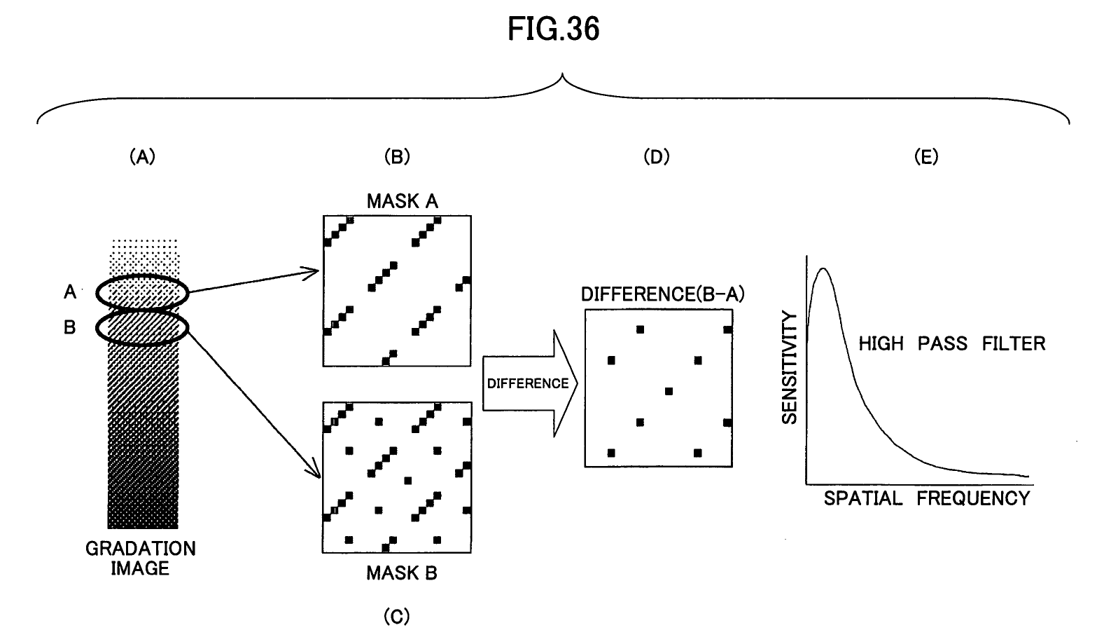

FIG. 36 is for explaining a differential image of the A mask and the B mask. That is, as shown in FIG. 36-(A), if the difference (B-A) of the A mask as shown in FIG. 36-(B) and the B mask as shown in FIG. 36-(C) between the dot at the A part using the A mask and the dot at the B part using the B mask is made, a difference image, namely a difference pattern, shown in FIG. 36-(D) is obtained. Such a difference image has a high pass filter as shown in FIG. 36-(E).

Thus, by the matrix preventing low-lines, it is possible to improve the continuity of the line keytone in a predetermined direction so that the multi-level image having a desirable quality by a continuing gradation technique can be reproduced. In addition, as compared with the error diffusion method, the process becomes simple by using the mask method so that a processing speed such as a printing speed, an image processing speed or image forming speed, can be high. In this case, by setting the direction of the line keytone is as an inclined direction or setting the line keytone to a line-group keytone, the line keytone in the inclined direction reduces a noise in a horizontal line shape by the image forming apparatus so that a high quality multi-level gradation image can be obtained.

By decomposing a multi color image into plural color components and applying an image processing method of multi colors wherein an original image of at least one color component is an input image, it is possible to output a high quality multi color image.

In a multi color image forming apparatus such as a color printing apparatus, three basic colors are used, cyan, magenta, and yellow, which are secondary colors. In addition, in an inkjet color printing apparatus, four primary colors, namely the above-mentioned three colors and black, are mainly used so as to improve brightness and external appearance of a desirable color. Furthermore, in order to improve printing quality, multi-colors made by combining basic colors are prepared in advance so that more colors are used for printing.

According to the above-mentioned apparatus, a multi color image forming method, wherein the decomposition to plural color components is done and an original image of the color component is used as an input image, carries out the pseudo gradation representation process for color composition units. Therefore, the continuity of the line keytone for the color component unit is improved so that a higher quality image can be formed as a single color image or a multi-color image.

Particularly, in an image forming apparatus wherein the matrix is used so as to convert to the image data having a dot binary value or multi-level values, it is possible to make the image forming speed or printing speed high and make the image quality high by applying the present invention to a case where an image is formed at a low resolution equal to or less than approximately 300 dpi.

That is, in the image forming apparatus using a pseudo gradation representation process, a dot density per unit, namely a resolution, is improved so that image quality is improved. However, in a case where the resolution is improved, the amount of image data simultaneously processed becomes large per unit area so that more processing time is required. In the pseudo modulation representation process in the image forming apparatus having a resolution of 300 dpi, approximately 150 lines as a maximum being expressed per one inch is a limitation and therefore it is difficult to make a high quality image.

In the pseudo gradation representation process by the dither matrix having a line keytone in a predetermined direction, low lines are generated at a dot of a low part in human visual acuity. Particularly at the resolution of 300 dpi, the line becomes low so that continuity of the gradation representation is broken and an image is degraded. In a case where the image is formed at an output having a low resolution in such an image forming apparatus, low line generation is prevented and the continuity of the line keytone in a predetermined direction is improved so that a multi-level gradation image having a desirable quality can be formed by a continuous gradation representation.

Next, a relationship between the halftone processing method as a gradation reproducing method and the γ correction is discussed. As described above, the γ correction is used for correcting the dot of the image data output corresponding to the input/output characteristic of the image forming apparatus. For example, in a case where an image forming apparatus has an input and output characteristic wherein an output result is smaller than an input, correction is made so that a higher gradation is made and thereby an output image becomes deep. On the other hand, in a case where an image forming apparatus for printing has an input and output characteristic wherein the output result is larger than the input, correction is made so that a lower gradation is made and thereby the output image becomes light.

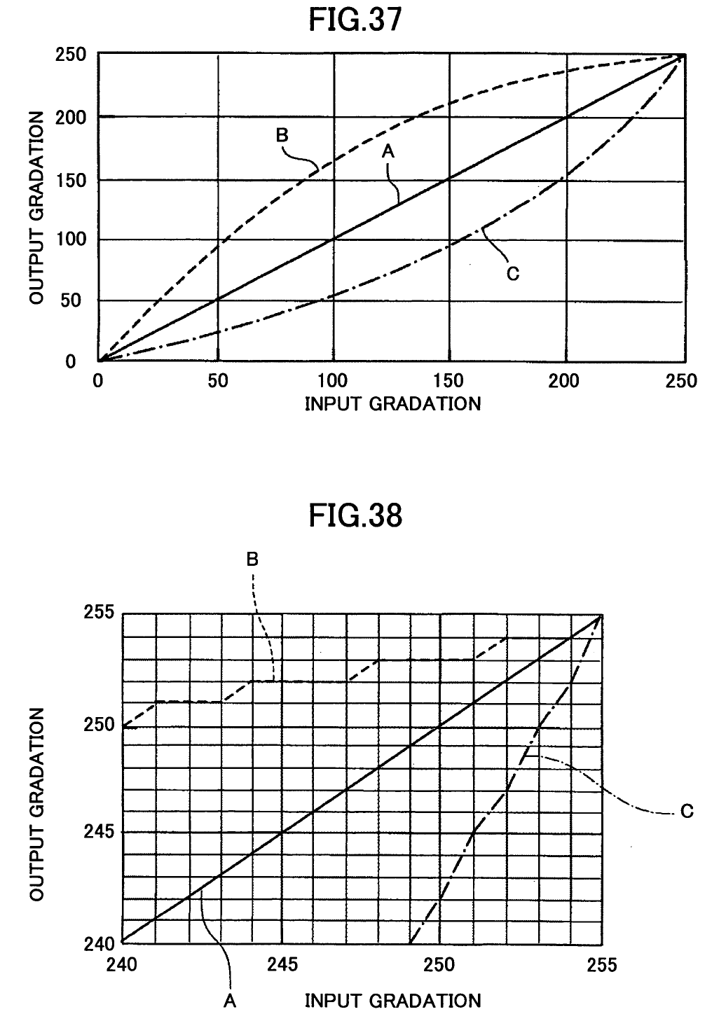

FIG. 37 is a graph showing an input and output characteristic in a case where the γ correction is used. The above-mentioned characteristic (γ curve) of the dot conversion curve at the γ correction becomes a curve expanding upward as shown in a dotted line b in FIG. 37 or a curve downward as shown in a one point dotted line c in FIG. 37 against an ideal input and output characteristic (input gradation is the same as the output gradation) as shown by a solid line a in FIG. 37.

In the normal image process, after the y correction is made to the multi-level gradation image data so that an output gradation is corrected and a necessary process is performed, the above-mentioned half tone process is performed on the multi-level image data so as to convert the multi-level image data to plural-level image data.

However, for example, in the dither method as a half tone process method as a gradation reproducing method, a threshold value is assigned to the dither matrix (threshold matrix) 105 used for changing the multi-level image data into the plural-level image data having an amount of information less than the multi-level image data so that the number of the increasing of dots for every gradation becomes constant or a brightness linear toward a maximum gradation is obtained.

Because of this, in a case of an image forming apparatus having 256 values of the input image data and 256 values of the number of gradation reproducing by the half tone process, it is possible to reproduce 256 values in a case where the input corresponds to the output. In a case where the input and output characteristic has a curve, the number of gradation that can be reproduced can be decreased. That is, for example, as shown in FIG. 38 that is an enlargement of FIG. 37 in the vicinity of 255 gradation of FIG. 37, in a case where an actual input and output characteristic as shown by a dotted line b becomes a curve expanding upward against the ideal input and output characteristic shown by a solid line a, a gradation area where an output gradation is not changed even if an input gradation is changed is in the vicinity of the high gradation. Similarly, in a case where an actual input and output characteristic as shown by a dotted line b becomes a curve expanding downward against the ideal input and output characteristic shown by the solid line a, a gradation area where an output gradation is not changed even if an input gradation is changed is in the vicinity of the low gradation.

According to this embodiment, in the dither matrix 105 used when the gradation is reproduced by converting the multi-level image data to the plural-level image data having an amount of information smaller than the plural-level image data, the assignment of the threshold value is not done in a state where the number of the increasing of dots for every gradation becomes constant or a brightness linear toward a maximum gradation is obtained but has a characteristic of the dot conversion curve.

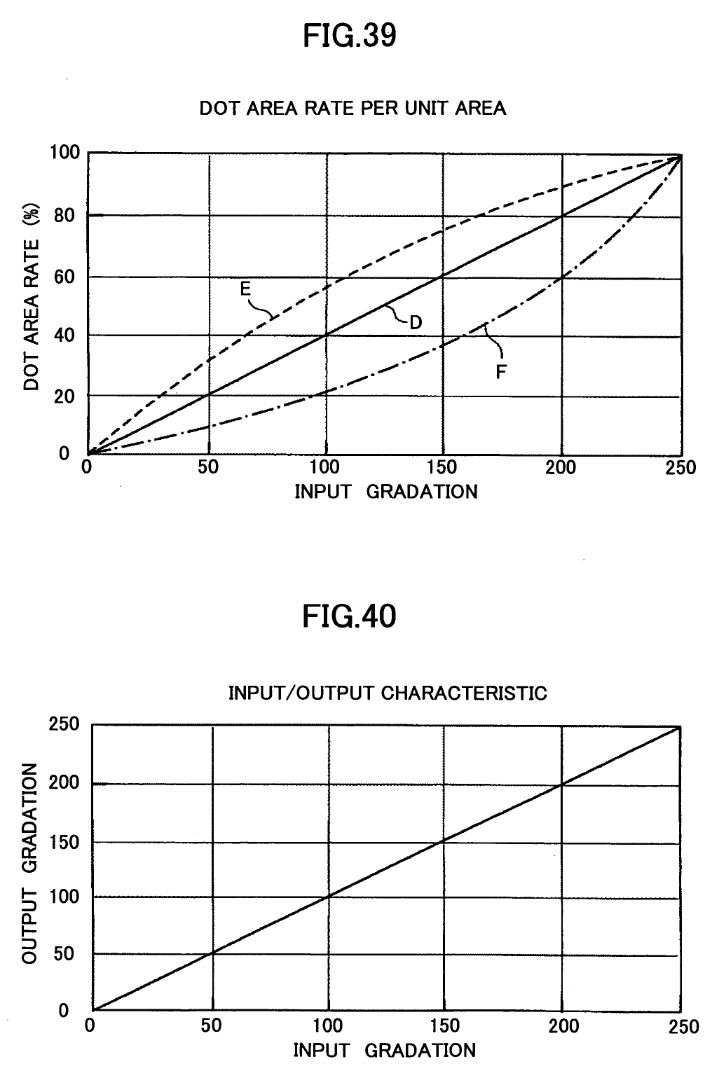

That is, the threshold value of the dither matrix 105 is set so that the dot area rate per unit area is the same as the characteristic of the dot conversion curve so that the number or size of the dots for every gradation is controlled. In other words, as shown in FIG. 39, by setting the threshold value of the dither matrix 105, the changed curve of the dot area rate against the input gradation can be changed as shown by a solid line d, a dotted line e, and a one dashed line f. Here, FIG. 39 is a graph showing an example where dot area rates for every gradation in the dither matrix having the γ characteristic are varied. The threshold value is set so that a change curve of the dot area rate is the same as a characteristic of the dot conversion curve.

Because of this, while the number of 256 gradations is maintained, as shown in FIG. 40, an input and output characteristic wherein the input always corresponds to the output can be made so that a high quality image having no decrease of the number of the gradations can be formed. Here, FIG. 40 is a graph showing an example of the input and output characteristic in a case where the dither matrix having the γ characteristic is used.

Thus, when the gradation of the multi-level image data is reproduced by converting the multi-level image data to the plural-level image data having an amount of information smaller than the multi-level image data, it is possible to form a high quality image without decreasing the number of gradations by implementing the converting process by using a part having a characteristic of the dot conversion curve. In this case, the γ correction due to the characteristic of the dot conversion curve is not necessary so that it is possible to improve a processing speed.

In other words, when the half tone process is implemented, the conversion is done by following the characteristic of the γ correction so that a high quality image without decreasing the number of gradations can be formed. As a result of this, it is not necessary to implement the γ correction prior to the half tone process so that processing speed can be improved.

In this case, it is possible to form a high quality image having no reduction of the number of gradation regarding a monochrome image or black color, by using a part having a characteristic of the dot conversion curve for black. In addition, it is possible to form a high quality image having no reduction of the number of gradation regarding a color image by using a part having a characteristic of the dot conversion curve for color. Furthermore, it is possible to form a high quality image having no reduction of the number of gradation regarding a color image or a single color image by using a part having a characteristic of the dot conversion curve for color composition unit.

By installing a program making a computer implement the above-discussed gradation reproducing method in a printer driver, it is possible to form a high quality image without decreasing of the number of gradations. The process speed can be improved without separately making the γ correction. In addition, the dot conversion curve table is not necessary so that a program size can be made small.

In a case where the dot area rate per unit area is changed by changing the assignment of the threshold value of the dither matrix, as discussed above, since the dither method carries out the gradation reproducing by modulating the number of the dots or dot sizes, it is possible to make a characteristic of the dot conversion curve by changing at least the number of dots or dot size, depending on a using way.

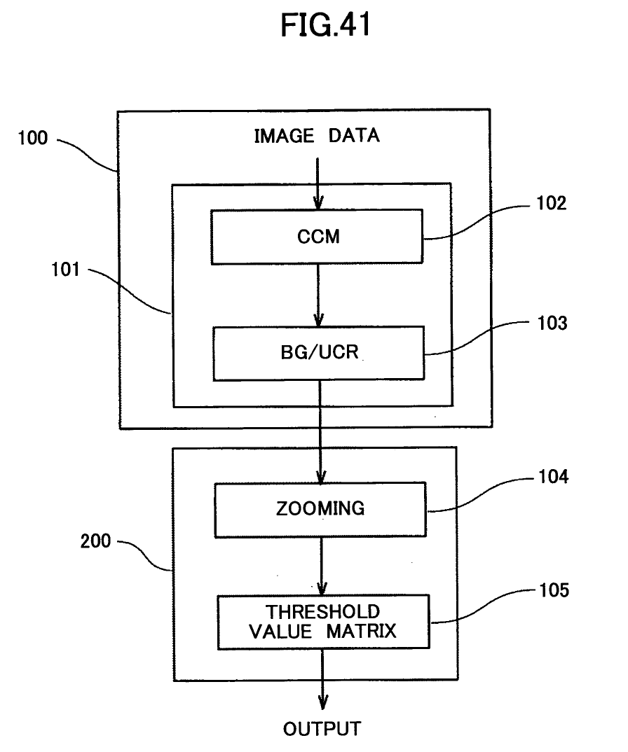

FIG. 41 is a system block diagram showing another embodiment of the image forming apparatus according to the present invention. In the host unit 100 shown in FIG. 41, the printer driver 101 includes only a CMM process section 102 and a BG/UCR section 103, which process the image data from application software or the like executed by the host computer 100. A zooming process section 104 and a threshold value matrix (table) 105 are provided in a controller of an ink-jet printer 200. The threshold value matrix (table) 105 is formed by a ROM or the like which stores the threshold value matrix of the present invention. Hence, the conversion of the dot layout is made in the ink-jet printer 200 in this case.

Thus, it is possible to form a high quality image without decreasing the number of gradation by implementing an above-mentioned gradation reproducing method at a side of an image forming apparatus forming an image consisting of plural dots. In addition, it is not necessary to separately implement the γ correction so that processing speed can be improved. Furthermore, it is not necessary to provide a dot conversion curve table so that mounted memory capacity can be reduced.

In the embodiment described above, the present invention is applied in particular to the host unit and the inkjet recording apparatus (image forming apparatus). However, the present invention is similarly applicable to any type of image forming apparatus which forms an image by dots, that is, forms the image by dot representation. Hence, the present invention is applicable to thermal transfer type image forming apparatuses (printers) or a thermal printer using a thermal energy, for example. The present invention is also applicable to electrophotography type image forming apparatuses such as laser printers and LED printers.

The present invention is not limited to the above-discussed embodiments, but variations and modifications may be made without departing from the scope of the present invention.

This patent application is based on Japanese Priority Patent Application No. 2004-253768 filed on Sep. 1, 2004, the entire contents of which are hereby incorporated by reference.

What is claimed is:

1. A gradation reproducing method, comprising the step of:
converting multi-level image data into plural-level image data having an amount of information smaller than an amount of information of the multi-level image data, by using a part having a characteristic of a dot conversion curve, so that a gradation of the multi-level image data is reproduced.

2. The gradation reproducing method as claimed in claim 1,
wherein the part having the characteristic of the dot conversion curve has a characteristic of a dot conversion curve for black.

3. The gradation reproducing method as claimed in claim 1,
wherein the part having the characteristic of the dot conversion curve has a characteristic of a dot conversion curve for a color.

4. The gradation reproducing method as claimed in claim 2,
wherein the part having the characteristic of the dot conversion curve has a characteristic of a dot conversion curve for a color.

5. The gradation reproducing method as claimed in claim 3,
wherein the characteristic of the dot conversion curve for the color is a characteristic of a dot conversion curve of a color component unit.

6. The gradation reproducing method as claimed in claim 4,
wherein the characteristic of the dot conversion curve for the color is a characteristic of a dot conversion curve of a color component unit.

7. The gradation reproducing method as claimed in claim 1,
wherein the part having the characteristic of the dot conversion curve is a dither matrix.

8. The gradation reproducing method as claimed in claim 2,
wherein the part having the characteristic of the dot conversion curve is a dither matrix.

9. The gradation reproducing method as claimed in claim 3,
wherein the part having the characteristic of the dot conversion curve is a dither matrix.

10. The gradation reproducing method as claimed in claim 5,
wherein the part having the characteristic of the dot conversion curve is a dither matrix.

11. The gradation reproducing method as claimed in claim 1,
wherein the characteristic of the dot conversion curve is obtained by at least a dot size modulation or a dot area rate per unit area.

12. The gradation reproducing method as claimed in claim 2,
wherein the characteristic of the dot conversion curve is obtained by at least a dot size modulation or a dot area rate per unit area.

13. The gradation reproducing method as claimed in claim 3,
wherein the characteristic of the dot conversion curve is obtained by at least a dot size modulation or a dot area rate per unit area.

14. The gradation reproducing method as claimed in claim 5,
wherein the characteristic of the dot conversion curve is obtained by at least a dot size modulation or a dot area rate per unit area.

15. The gradation reproducing method as claimed in claim 10,
wherein the characteristic of the dot conversion curve is obtained by at least a dot size modulation or a dot area rate per unit area.

16. An image forming apparatus configured to form an image made of a plurality of dots, the image forming apparatus comprising:
a part having a characteristic of a dot conversion curve, the part converting multi-level image data into plural-level image data having an amount of information smaller than an amount of information of the multi-level image data, so that a gradation of the multi-level image data is reproduced.

17. The image forming apparatus as claimed in claim 16,
wherein the part having the characteristic of the dot conversion curve has a characteristic of a dot conversion curve for black.

18. A printer driver configured to process image data for an image forming apparatus forming an image made of a plurality of dots, the printer driver comprising:
a computer program whereby a gradation reproducing method is implemented by a computer;
wherein the gradation reproducing method includes the step of:
converting multi-level image data into plural-level image data having an amount of information smaller than an amount of information of the multi-level image data, by using a part having a characteristic of a dot conversion curve, so that a gradation of the multi-level image data is reproduced.

19. The printer driver as claimed in claim 18,
wherein the part having the characteristic of the dot conversion curve has a characteristic of a dot conversion curve for black.
